(19) United States
(12) Patent Application Publication
(10) Pub. No.: US 2026/0142280 A1
(43) Pub. Date: May 21, 2026

(54) CHARGING SYSTEM FOR METAL-AIR FLOW BATTERY AND METAL-AIR FLOW BATTERY

(71) Applicant: SHARP KABUSHIKI KAISHA, Saika City (JP)

(72) Inventors: SHINOBU TAKENAKA, Sakai City (JP); Hirotaka Mizuhata, Sakai City (JP)

(21) Appl. No.: 19/344,998

(22) Filed: Sep. 30, 2025

(30) Foreign Application Priority Data
Sep. 30, 2024 (JP) 2024-169751

(51) Int. Cl. H01M 12/02; H01M 12/08; H01M 50/46

(52) U.S. Cl. CPC H01M 12/02; H01M 12/08; H01M 50/46

(57) ABSTRACT

A charging system for a metal-air flow battery, includes: a first layer including a first flow channel; a positive electrode facing the first flow channel; a second layer including a second flow channel; a negative electrode facing the second flow channel; a separator separating the first and second flow channels from each other; a positive-electrode solution flowing through the first flow channel; and a negative-electrode solution flowing through the second flow channel, wherein the charging system for the metal-air flow battery has a time period during which hydrogen is generated in the negative electrode.

### CROSS-REFERENCE TO RELATED APPLICATION

The present application claims priority from Japanese Application JP2024-169751, the content of which is hereby incorporated by reference into this application.

### BACKGROUND OF THE INVENTION

### 1. Field of the Invention

The present disclosure relates to a charging system for a metal-air flow battery and a metal-air flow battery.

### 2. Description of the Related Art

U.S. Pat. No. 7,470,351 discloses a system that generates metal particles. This systems generates metal particles onto the cathode's surface through electrolysis of a solution containing dissolved metal. The generated metal particles, when reached a sufficient size, are removed from the cathode's surface by a scraper or other suitable means (paragraphs 0014 and 0057).

### SUMMARY OF THE INVENTION

The system disclosed in U.S. Pat. No. 7,470,351 has to move the scraper or other suitable means along the cathode's surface in order to remove the metal particles from the cathode's surface. This causes some problems, such as consumption of electric power necessary to move the scraper or other suitable means, and system degradation resulting from moving the scraper or other suitable means along the cathode's surface. Examples of problems include wear and degradation of the scraper and other suitable means, wear and degradation of the cathode, and system degradation resulting from clogging with the metal particles remaining unremoved from the cathode's surface.

One aspect of the present disclosure has been made in view of these problems. It is an object of one aspect of the present disclosure to provide a charging system for a metal-air flow battery and a metal-air flow battery that, for instance, can remove negative-electrode active-material particles from a negative electrode without large power consumption and are less likely to be subject to degradation.

A charging system for a metal-air flow battery according to a first aspect of the present disclosure includes the following: a first layer including a first flow channel; a positive electrode facing the first flow channel; a second layer including a second flow channel; a negative electrode facing the second flow channel; a separator separating the first and second flow channels from each other; a positive-electrode solution flowing through the first flow channel; and a negative-electrode solution flowing through the second flow channel. The charging system for the metal-air flow battery has a time period during which hydrogen is generated in the negative electrode.

A metal-air flow battery according to a second aspect of the present disclosure includes the following: the charging system for the metal-air flow battery according to the first aspect of the present disclosure; a discharging unit for the metal-air flow battery; and a controller configured to control at least one selected from the group consisting of the flow rate and the current in accordance with a depth of discharge in the discharging unit for the metal-air flow battery.

### BRIEF DESCRIPTION OF THE DRAWINGS

FIG. 1 schematically illustrates a metal-air flow battery according to a first embodiment;

FIG. 2 is a schematic exploded perspective view of a charging cell included in the metal-air flow battery according to the first embodiment;

FIG. 3 is a schematic cross-sectional view of the charging cell included in the metal-air flow battery according to the first embodiment;

FIG. 4A is a graph showing example time variations in current flowing between the positive and negative electrodes of the charging cell included in the metal-air flow battery according to the first embodiment and a fourth embodiment;

FIG. 4B is a graph showing example time variations in the flow rate of a negative-electrode solution in a second flow channel of a second layer of the charging cell included in the metal-air flow battery according to the first and fourth embodiments;

FIG. 5 is a flowchart showing a process that is performed by a control unit included in the metal-air flow battery according to the first embodiment;

FIG. 6A is a graph showing example time variations in the current flowing between the positive and negative electrodes of the charging cell included in the metal-air flow battery according to a first modification of the first embodiment and a first modification of the fourth embodiment;

FIG. 6B is a graph showing example time variations in the flow rate of the negative-electrode solution in the second flow channel of the second layer of the charging cell included in the metal-air flow battery according to the first modifications of the first and fourth embodiments;

FIG. 7A is a graph showing example time variations in the current flowing between the positive and negative electrodes of the charging cell included in the metal-air flow battery according to second and fifth embodiments;

FIG. 7B is a graph showing example time variations in the flow rate of the negative-electrode solution in the second flow channel of the second layer of the charging cell included in the metal-air flow battery according to the second and fifth embodiments;

FIG. 8 is a flowchart showing a process that is performed by the control unit included in the metal-air flow battery according to the second embodiment;

FIG. 9A is a graph showing example time variations in the current flowing between the positive and negative electrodes of the charging cell included in the metal-air flow battery according to a third embodiment;

FIG. 9B is a graph showing example time variations in the flow rate of the negative-electrode solution in the second flow channel of the second layer of the charging cell included in the metal-air flow battery according to the third embodiment;

FIG. 10 is a flowchart showing a process that is performed by the control unit included in the metal-air flow battery according to the third embodiment;

FIG. 11A is a graph showing example time variations in the current flowing between the positive and negative electrodes of the charging cell included in the metal-air flow battery according to a first modification of the third embodiment and a first modification of a sixth embodiment;

FIG. 11B is a graph showing example time variations in the flow rate of the negative-electrode solution in the second flow channel of the second layer of the charging cell included in the metal-air flow battery according to the first modifications of the third and sixth embodiments;

FIG. 12A is a graph showing example time variations in the current flowing between the positive and negative electrodes of the charging cell included in the metal-air flow battery according to a second modification of the third embodiment and a second modification of the sixth embodiment;

FIG. 12B is a graph showing example time variations in the flow rate of the negative-electrode solution in the second flow channel of the second layer of the charging cell included in the metal-air flow battery according to the second modifications of the third

### And Sixth Embodiments;

FIG. 13 is a flowchart showing a process that is performed by the control unit included in the metal-air flow battery according to the second modification of the third embodiment;

FIG. 14 schematically illustrates the metal-air flow battery according to the fourth embodiment;

FIG. 15 is a flowchart showing a process that is performed by the control unit included in the metal-air flow battery according to the fourth embodiment;

FIG. 16 is a flowchart showing a process that is performed by the control unit included in the metal-air flow battery according to the fifth embodiment;

FIG. 17 is a flowchart showing a process that is performed by the control unit included in the metal-air flow battery according to the sixth embodiment;

FIG. 18 is a flowchart showing a process that is performed by the control unit included in the metal-air flow battery according to the second modification of the sixth embodiment;

FIG. 19 illustrates a process that is performed by the control unit included in the metal-air flow battery according to a seventh embodiment;

FIG. 20 illustrates a process that is performed by the control unit included in the metal-air flow battery according to the seventh embodiment;

FIG. 21 illustrates a process that is performed by the control unit included in the metal-air flow battery according to the seventh embodiment; and

FIG. 22 illustrates a process that is performed by the control unit included in the metal-air flow battery according to the seventh embodiment.

### DETAILED DESCRIPTION OF THE INVENTION

Embodiments of the present disclosure will be described with reference to the drawings. It is noted that identical or equivalent constituents will be denoted by the same signs throughout the drawings, and the descriptions of redundancies will be omitted.

### 1 First Embodiment

### 1.1. Metal-Air Flow Battery

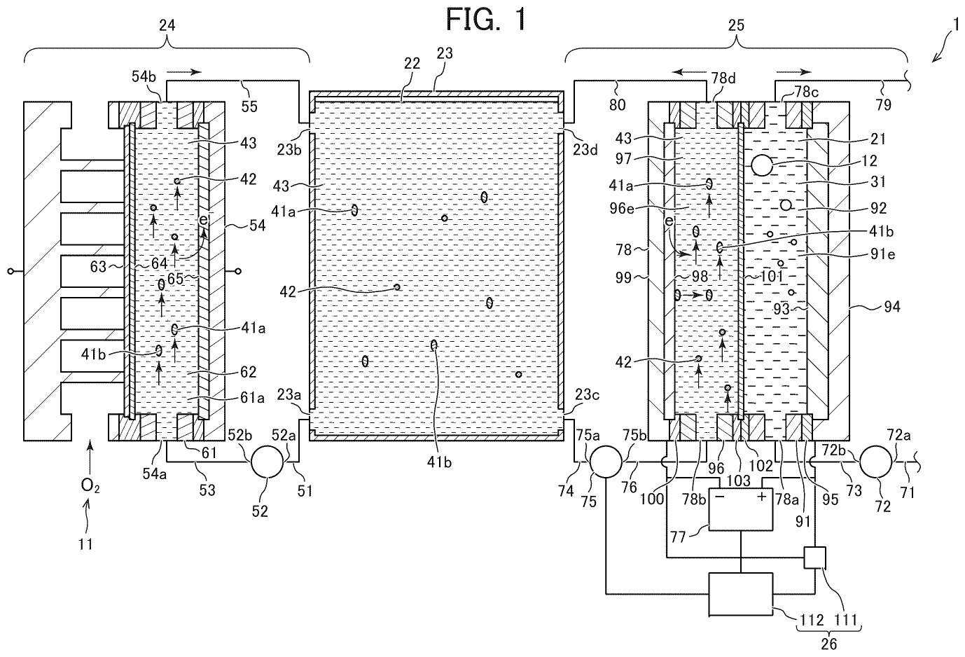

FIG. 1 schematically illustrates a metal-air flow battery according to a first embodiment.

A metal-air flow battery 1 according to the first embodiment illustrated in FIG. 1 absorbs oxygen gas 11 from air around the metal-air flow battery 1 during its discharge. The metal-air flow battery 1 discharges oxygen gas 12 to the air around the metal-air flow battery 1 during its charge.

The metal-air flow battery 1 is a zinc-air flow battery. The metal-air flow battery 1 thus has a negative-electrode active material that is a zinc species. However, the metal-air flow battery 1 may be a metal-air flow battery other than a zinc-air flow battery. The metal-air flow battery 1 may thus have a negative-electrode active material that is a metal species other than a zinc species. Examples of the metal species other than a zinc species include a cadmium species, a lithium species, a sodium species, a magnesium species, a lead species, a tin species, an aluminum species, and an iron species. The metal constituting the metal species may be a metal only that is a major constituent, or an alloy of a metal that is a major constituent and an accessory constituent. The metal species can be either a metal or an oxide. That the metal species is either a metal or an oxide depends on how much a discharge reaction or a charge reaction progresses.

As illustrated in FIG. 1, the metal-air flow battery 1 includes a positive-electrode solution 21, a negative-electrode solution 22, a storage unit 23, a discharging unit 24, a charging unit 25, and a controller 26.

### 1.2 Positive-Electrode Solution

As illustrated in FIG. 1, the positive-electrode solution 21 includes a first electrolytic solution 31.

The first electrolytic solution 31 is a potassium hydroxide aqueous solution. The first electrolytic solution 31 may be an aqueous solution other than a potassium hydroxide aqueous solution, or an electrolytic solution other than an aqueous solution.

The water contained in the first electrolytic solution 31 is a reactant of a charge reaction, which occurs in the charging unit 25.

### 1.3 Negative-Electrode Solution

As illustrated in FIG. 1, the negative-electrode solution 22 includes negative-electrode active-material particles 41a in a reduction state, negative-electrode active-material particles 41b in an oxidation state, negative-electrode active-material ions 42, and a second electrolytic solution 43.

As earlier described, the metal-air flow battery 1 is a zinc-air flow battery. The negative-electrode active-material particles 41a in the reduction state, the negative-electrode active-material particles 41b in the oxidation state, and the negative-electrode active-material ions 42 are thus zinc species. The negative-electrode active-material particles 41a in the reduction state are metal zinc (Zn) particles, and the negative-electrode active-material particles 41b in the oxidation state are zinc oxide (ZnO) particles. The negative-electrode active-material particles 41a in the reduction state and the negative-electrode active-material particles 41b in the oxidation state are dispersed in the second electrolytic solution 43. The negative-electrode solution 22 thus has a slurry property. The negative-electrode active-material particles 41a in the reduction state have a particle diameter of several micrometers for instance, and the negative-electrode active-material particles 41b in the oxidation state have a particle diameter of several tens to several hundred nanometers for instance. The negative-electrode active-material ions 42 are zincate ions (Zn(OH)₄ ²⁻) and dissolved in the second electrolytic solution 43.

The second electrolytic solution 43 is a potassium hydroxide aqueous solution. The second electrolytic solution 43 may be an aqueous solution other than a potassium hydroxide aqueous solution, or an electrolytic solution other than an aqueous solution.

The negative-electrode active-material ions 42 are a reactant of the charge reaction in the charging unit 25. The negative-electrode active-material particles 41a in the reduction state are a product of the charge reaction in the charging unit 25.

### 1.4 Storage Unit

The storage unit 23 stores the negative-electrode solution 22. The storage unit 23 includes an outlet 23a, an inlet 23b, an outlet 23c, and an inlet 23d. The outlets 23a and 23c let the negative-electrode solution 22 out. The inlets 23b and 23d let the negative-electrode solution 22 in.

### 1.5 Discharging Unit

The discharging unit 24 absorbs the oxygen gas 11 from air around the discharging unit 24. The discharging unit 24 receives the negative-electrode solution 22 from the storage unit 23. The discharging unit 24 causes the absorbed oxygen gas 11 and received negative-electrode solution 22 to get involved in a discharge reaction for generating discharging power, and causes the negative-electrode solution 22 involved in the discharge reaction to flow out to the storage unit 23. The discharging unit 24 causes the oxygen gas 11 and the negative-electrode active-material particles 41a in the reduction state contained in the negative-electrode solution 22 to get involved in the discharge reaction, to vanish the negative-electrode active-material particles 41a in the reduction state and generate the negative-electrode active-material ions 42.

As illustrated in FIG. 1, the discharging unit 24 includes a pipe 51, a pump 52, a pipe 53, a discharging cell 54, and a pipe 55.

The pipe 51 guides the negative-electrode solution 22 from the outlet 23a of the storage unit 23 to an inlet 52a of the pump 52. Accordingly, the pipe 51 allows the negative-electrode solution 22 flowed out of the outlet 23a to flow into the inlet 52a.

The pump 52 allows the negative-electrode solution 22 flowed into the inlet 52a of the pump 52 to flow out of the outlet 52b of the pump 52. The pump 52 generates a flow of the negative-electrode solution 22 at this time. Accordingly, the pipe 52 sends the negative-electrode solution 22 from the storage unit 23 to the discharging cell 54.

The pipe 53 guides the negative-electrode solution 22 from the outlet 52b of the pump 52 to the inlet 54a of the discharging cell 54. Accordingly, the pipe 53 allows the negative-electrode solution 22 flowed out of the outlet 52b to flow into the inlet 54a.

The discharging unit 54 absorbs the oxygen gas 11 from air around the discharging cell 54. The discharging cell 54 allows the negative-electrode solution 22 flowed into the inlet 54a of the discharging cell 54 to flow out of the outlet 54b of the discharging cell 54. The discharging cell 54 at this time causes the absorbed oxygen gas 11 and received negative-electrode solution 22 to get involved in the discharge reaction, and causes the negative-electrode solution 22 involved in the discharge reaction to flow out of the outlet 54b. The discharging cell 54 outputs discharge power generated through the discharge reaction.

The pipe 55 guides the negative-electrode solution 22 from the outlet 54b of the discharging cell 54 to the inlet 23b of the storage unit 23. Accordingly, the pipe 55 allows the negative-electrode solution 22 flowed out of the outlet 54b to flow into the inlet 23b.

### 1.6 Discharging Cell

As illustrated in FIG. 1, the discharging cell 54 includes a layer 61, a negative-electrode solution 62, a positive electrode 63, a separator 64, and a negative electrode 65.

The layer 61 includes a flow channel 61a. The flow channel 61a extends from the inlet 54a to outlet 54b of the discharging cell 54. The flow channel 61a thus allows the negative-electrode solution 22 flowed into the inlet 54a to pass therethrough and flow out of the outlet 54b.

The negative-electrode solution 62 flows through the flow channel 61a of the layer 61. The negative-electrode solution 62 is a part of the negative-electrode solution 22 included in the metal-air flow battery 1.

The positive electrode 63 is in contact with the air around the discharging cell 54. The positive electrode 63 is thus supplied with the oxygen gas 11, which is contained in the air around the discharging cell 54. Accordingly, an oxygen reduction reaction expressed by Chemical Equation (1) occurs in the positive electrode 63.

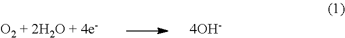

The positive electrode 63 faces the flow channel 61a of the layer 61 with the separator 64 interposed therebetween. The positive electrode 63 thus passes OH⁻, which is a product of the oxygen reduction reaction expressed by Chemical Equation (1), to the negative-electrode solution 62 flowing through the flow channel 61a by way of the separator 64.

The negative electrode 65 faces the flow channel 61a of the layer 61. The negative electrode 65 is thus in contact with the negative-electrode solution 62 flowing through the flow channel 61a. Accordingly, a zinc-metal oxidation reaction expressed by Chemical Equations (2) and (3) occurs in the negative electrode 65.

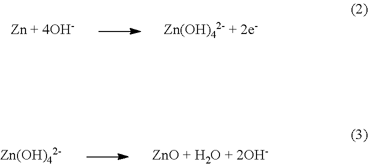

Through the oxygen reduction reaction in the positive electrode 63 and the zinc-metal oxidation reaction in the negative electrode 65, an overall reaction expressed by Chemical Equation (4) occurs in the discharging cell 54.

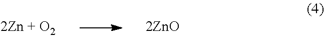

Accordingly, the discharging cell 54 discharges electricity when the zinc metal turns into zinc oxide.

### 1.7 Charging Unit

The charging unit 25 receives the negative-electrode solution 22 from the storage unit 23. The charging unit 25 causes the received negative-electrode solution 22 to get involved in a charge reaction for reproducing the negative-electrode solution 22, and causes the negative-electrode solution 22 involved in the charge reaction to flow out to the storage unit 23. The charging unit 25 causes the negative-electrode active-material ions 42 contained in the negative-electrode solution 22 to get involved in the charge reaction, to vanish the negative-electrode active-material ions 42 and generate the negative-electrode active-material particles 41a in the reduction state.

As illustrated in FIG. 1, the charging unit 25 includes a pipe 71, a pump 72, a pipe 73, a pipe 74, a pump 75, a pipe 76, a power supply 77, a charging cell 78, a pipe 79, and a pipe 80.

The pipe 71 guides the positive-electrode solution 21 from a supply source (not shown) of the positive-electrode solution 21 to an inlet 72a of the pump 72. Accordingly, the pipe 71 allows the positive-electrode solution 21 flowed out of the supply source of the positive-electrode solution 21 to flow into the inlet 72a.

The pump 72 causes the positive-electrode solution 21 flowed into the inlet 72a of the pump 72 to flow out of an outlet 72b of the pump 72. The pump 72 generates a flow of the positive-electrode solution 21 at this time. The pump 72 thus sends the positive-electrode solution 21 from the supply source of the positive-electrode solution 21 to the charging cell 78.

The pipe 73 guides the positive-electrode solution 21 from the outlet 72b of the pump 72 to an inlet 78a of the charging cell 78. Accordingly, the pipe 73 allows the positive-electrode solution 21 flowed out of the outlet 72b to flow into the inlet 78a.

The pipe 74 guides the negative-electrode solution 22 from the outlet 23c of the storage unit 23 to an inlet 75a of the pump 75. Accordingly, the pipe 74 allows the negative-electrode solution 22 flowed out of the outlet 23c to flow into the inlet 75a.

The pump 75 causes the negative-electrode solution 22 flowed into the inlet 75a of the pump 75 to flow out of an outlet 75b of the pump 75. The pump 75 generates a flow of the negative-electrode solution 22 at this time. Accordingly, the pump 75 sends the negative-electrode solution 22 from the storage unit 23 to the charging cell 78. The flow of the negative-electrode solution 22 can be reversed by changing the directions of the outflow and inflow of the pump 75.

The pipe 76 guides the negative-electrode solution 22 from the outlet 75b of the pump 75 to an inlet 78b of the charging cell 78. Accordingly, the pipe 76 allows the negative-electrode solution 22 flowed out of the outlet 75b to flow into the inlet 78b.

The power supply 77 inputs charging power to the charging cell 78.

The charging cell 78 causes the positive-electrode solution 21 flowed into the inlet 78a of the charging cell 78 to flow out of an outlet 78c of the charging cell 78, and causes the negative-electrode solution 22 flowed into the inlet 78b of the charging cell 78 to flow out of an inlet 78d of the charging cell 78. The charging cell 78 at this time causes the flowed positive-electrode solution 21 and negative-electrode solution 22 to get involved in a charge reaction caused by the charging power, causes the positive-electrode solution 21 involved in the charge reaction to flow out of the outlet 78c, causes the negative-electrode solution 22 involved in the charge reaction to flow out of an outlet 78d, and discharges the oxygen gas 12 generated through the charge reaction to air around the charging cell 78.

The pipe 79 guides the positive-electrode solution 21 from the outlet 78c of the pump 78 to the supply source of the positive-electrode solution 21. Accordingly, the pipe 79 allows the positive-electrode solution 21 flowed out of the outlet 78c to flow into the supply source of the positive-electrode solution 21.

The pipe 80 guides the negative-electrode solution 22 from the outlet 78d of the charging cell 78 to the inlet 23d of the storage unit 23. Accordingly, the pipe 80 allows the negative-electrode solution 22 flowed out of the outlet 78d to flow into the inlet 23d.

### 1.8 Charging Cell

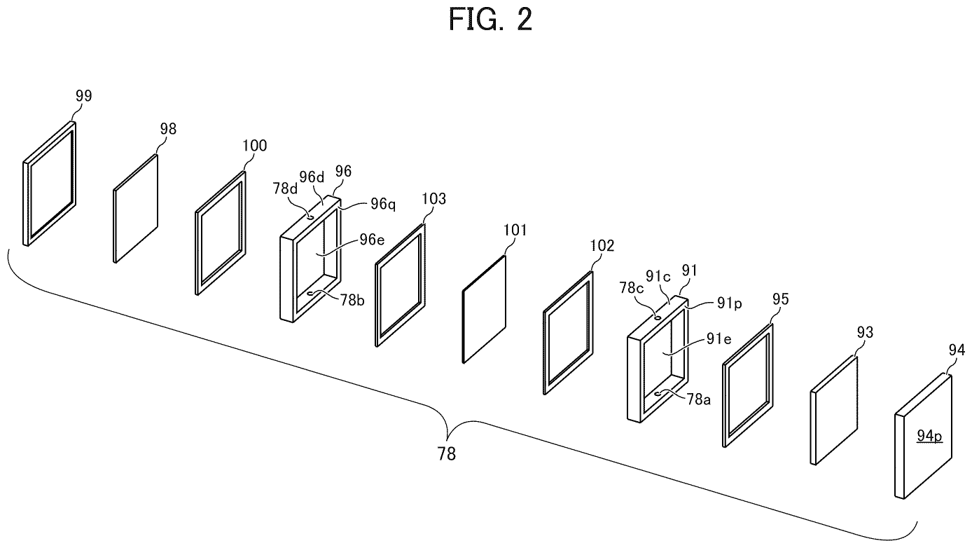

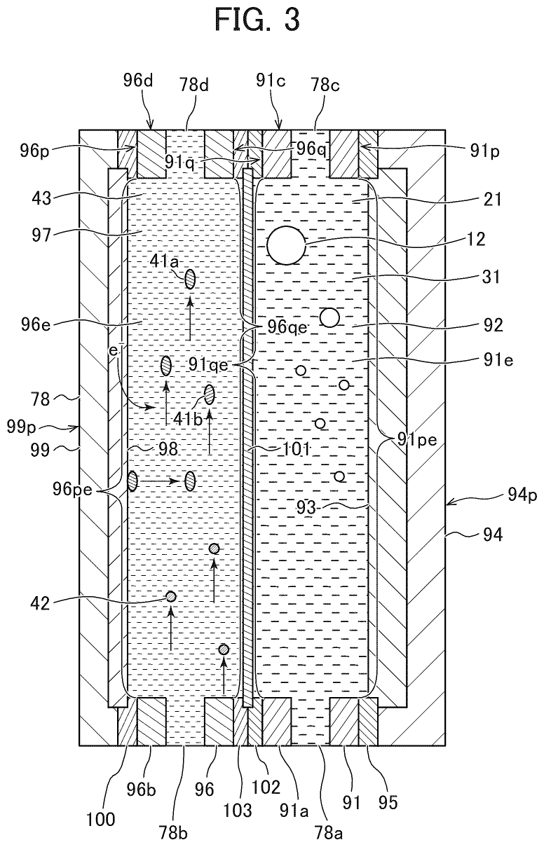

FIG. 2 is a schematic exploded perspective view of the charging cell included in the metal-air flow battery according to the first embodiment. FIG. 3 is a schematic cross-sectional view of the charging cell included in the metal-air flow battery according to the first embodiment.

As illustrated in FIGS. 2 and 3, the discharging cell 78 includes a first layer 91, a positive-electrode solution 92, a positive electrode 93, an energization plate 94, a gasket 95, a second layer 96, a negative-electrode solution 97, a negative electrode 98, an energization plate 99, a gasket 100, a separator 101, a gasket 102, and a gasket 103.

The first layer 91 has a rectangular frame shape. The first layer 91 thus has an opening surface 91p, an opening surface 91q, an end surface 91a, and an end surface 91c. The opening surfaces 91p and 91q are opposite to each other. The end surfaces 91a and 91c are opposite to each other. The first layer 91 may have a frame shape other than a rectangular frame shape.

The first layer 91 includes a first flow channel 91e.

The first flow channel 91e of the first layer 91 is exposed to the opening surfaces 91p and 91q and has an opening 91pe on the opening surface 91p, and an opening 91qe on the opening surface 91q.

The first flow channel 91e of the first layer 91 is exposed to the end surfaces 91a and 91c and has the inlet 78a on the end surface 91a, and the outlet 78c on the end surface 91c. The first flow channel 91e thus extends from the inlet 78a to the outlet 78c. The flow channel 61a thus allows the positive-electrode solution 92 flowed into the inlet 78a to pass therethrough and flow out of the outlet 78c.

The inlet 78a and outlet 78c of the charging cell 78 are disposed on the lower side and the upper side, respectively. The first flow channel 91e of the first layer 91 thus guides the positive-electrode solution 92 from bottom to top. The inlet 78a may be disposed in a position other than the lower side, and the outlet 78c may be disposed in a position other than the upper side.

The positive-electrode solution 92 flows through the first flow channel 91e of the first layer 91. The positive-electrode solution 92 is a part of the positive-electrode solution 21. As earlier described, the inlet 78a and outlet 78c of the charging cell 78 are disposed on the lower side and the upper side, respectively. The positive-electrode solution 92 thus flows through the first flow channel 91e from bottom to top.

When the positive-electrode solution 92 flows from top to bottom, the positive-electrode solution 92 flows down from the first flow channel 91e even before the first flow channel 91e of the first layer 91 is completely filled with the positive-electrode solution 92. There is hence a possibility that the first flow channel 91e cannot be completely filled with the positive-electrode solution 92. In contrast to this, when the positive-electrode solution 92 flows from bottom to top, the positive-electrode solution 92 overflows from the first flow channel 91e after the first flow channel 91e is completely filled with the positive-electrode solution 92. The first flow channel 91e can be thus completely filled with the positive-electrode solution 92.

The oxygen gas 12 generated in the positive electrode 93 not only moves from bottom to top thanks to a buoyant force, but also moves from bottom to top along the flow of the positive-electrode solution 92. This can promote the discharge of the oxygen gas 12 from the charging cell 78.

The positive electrode 93 has a rectangular plate shape. The positive electrode 93 is disposed on the opening surface 91p of the first layer 91. The positive electrode 93 thus closes the opening 91pe of the first layer 91 and faces the first flow channel 91e of the first layer 91. The positive electrode 93 is thus in contact with the positive-electrode solution 92 flowing through the first flow channel 91e. Accordingly, a water oxidation reaction expressed by Chemical Equation (5) occurs in the positive electrode 93.

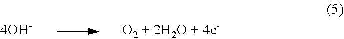

Accordingly, the charging cell 78 generates the oxygen gas 12 by the water oxidation reaction in the positive electrode 93. The generated oxygen gas 12 is discharged from the charging cell 78.

The positive electrode 93 is made of a material, such as metal, spinel conductive oxide, perovskite conductive oxide. The metal is a foamed nickel or other metals. The spinel conductive oxide includes nickel, cobalt, and other things.

The energization plate 94 has a rectangular plate shape. The energization plate 94 is disposed on the opening surface 91p of the first layer 91 so as to overlap the positive electrode 93. The energization plate 94 is thus in contact with the positive electrode 93 to constitute an energization channel to the positive electrode 93.

The gasket 95 is sandwiched by the opening surface 91p of the first layer 91, the positive electrode 93, and the energization plate 94, and it closes the opening surface 91p of the first layer 91 and the positive electrode 93 as well as the energization plate 94 in a liquid-tight manner.

The second layer 96 has a rectangular frame shape. The second layer 96 thus has an opening surface 96p, an opening surface 96q, an end surface 96b, and an end surface 96d. The opening surfaces 96p and 96q are opposite to each other. The end surfaces 96b and 96d are opposite to each other.

The second layer 96 includes a second flow channel 96e.

The second flow channel 96e of the second layer 96 is exposed to the opening surfaces 96p and 96q and has an opening 96pe on the opening surface 96p, and an opening 96qe on the opening surface 96q.

The second flow channel 96e of the second layer 96 is exposed to the end surfaces 96b and 96d and has the inlet 78b on the end surface 96b, and the outlet 78d on the end surface 96d. The second flow channel 96e thus extends from the inlet 78b to the outlet 78d. The second flow channel 96e thus allows the negative-electrode solution 97 flowed into the inlet 78b to pass therethrough and flow out of the outlet 78d.

The inlet 78b and outlet 78d of the charging cell 78 are disposed on the lower side and the upper side, respectively. The second flow channel 96e of the second layer 96 thus guides the negative-electrode solution 97 from bottom to top.

The positive-electrode solution 97 flows through the second flow channel 96e of the second layer 96. The negative-electrode solution 97 is a part of the negative-electrode solution 22. As earlier described, the inlet 78b and outlet 78d of the charging cell 78 are disposed on the lower side and the upper side, respectively. The negative-electrode solution 97 thus flows through the second flow channel 96e from bottom to top.

When the negative-electrode solution 97 flows from top to bottom, the negative-electrode solution 97 flows down from the second flow channel 96e even before the second flow channel 96e of the second layer 96 is completely filled with the negative-electrode solution 97. There is hence a possibility that the second flow channel 96e cannot be completely filled with the negative-electrode solution 97. In contrast to this, when the negative-electrode solution 97 flows from bottom to top, the negative-electrode solution 97 overflows from the second flow channel 96e after the second flow channel 96e is completely filled with the negative-electrode solution 97. The second flow channel 96e can be thus completely filled with the negative-electrode solution 97.

The negative electrode 98 has a rectangular plate shape. The negative electrode 98 is disposed on the opening surface 96p of the second layer 96. The positive electrode 98 thus closes the opening 91pe of the second layer 96 and faces the second flow channel 96e of the second layer 96. The negative electrode 98 is thus in contact with the negative-electrode solution 97 flowing through the second flow channel 96e. The negative electrode 98 is thus supplied with a negative-electrode solution containing zincate ions (Zn(OH)₄ ²⁻), and/or zinc oxide (ZnO) both generated by the zinc-metal oxidation reaction expressed by Chemical Equations (2) and (3). Accordingly, a reduction reaction into zinc metal expressed by Chemical Equations (6) and (7) occurs in the negative electrode 98.

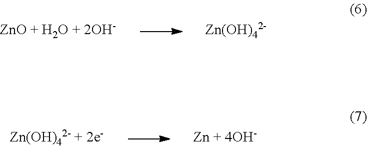

Accordingly, the charging cell 78 generates the negative-electrode active-material particles 41a in the reduction state through the reduction reaction into zinc metal in the negative electrode 98. The generated negative-electrode active-material particles 41a in the reduction state adhere to the negative electrode 98.

The negative electrode 98 is made of a conductive material. The conductive material is composed of a carbon material and a resin.

The energization plate 99 has a rectangular plate shape. The energization plate 99 is disposed on the opening surface 96p of the second layer 96 so as to overlap the negative electrode 98. The energization plate 99 is thus in contact with the negative electrode 98 to constitute an energization channel to the negative electrode 98.

The gasket 100 is sandwiched by the opening surface 96p of the second layer 96, the negative electrode 98, and the energization plate 99, and it closes the opening surface 96p of the second layer 96 and the negative electrode 98 as well as the energization plate 99 in a liquid-tight manner.

The separator 101 has a sheet shape. The separator 101 has flexibility. The separator 101 is disposed on the opening surface 91q of the first layer 91. The separator 101 thus closes the opening 91qe of the first layer 91 and faces the first flow channel 91e of the first layer 91. The separator 101 is also disposed on the opening surface 96q of the second layer 96. The separator 101 thus closes the opening 96qe of the second layer 96 and faces the second flow channel 96e of the second layer 96.

The separator 101 is sandwiched by the first layer 91 and the second layer 96. The separator 101 thus separates the first flow channel 91e of the first layer 91 and the second flow channel 96e of the second layer 96 from each other. The separator 101 does not allow the negative-electrode active-material particles 41a in the reduction state and the negative-electrode active-material particles 41b in the oxidation state to pass therethrough. The separator 101 thus prevents the negative-electrode active-material particles 41a in the reduction state and the negative-electrode active-material particles 41b in the oxidation state from moving from the negative-electrode solution 97 to the positive-electrode solution 92.

The separator 101 has high ion conductivity. The separator 101 thus allows hydroxide ions (OH⁻) to pass therethrough. This enables the hydroxide ions (OH⁻) to move from the negative-electrode solution 97 to the positive-electrode solution 92.

In the reduction reaction into zinc metal, i.e., an electrodeposition reaction of zinc metal, in the negative electrode 98, dendritic zinc metal may grow from the negative electrode 98 due to a non-uniform electric-current distribution. The separator 101 has high resistance to dendrites. The separator 101 thus inhibits the growth of dendritic zinc metal beyond the separator 101. This prevents a short circuit between the positive electrode 93 and the negative electrode 98 via dendritic zinc metal.

The gasket 102 is sandwiched by the opening surface 91q of the first layer 91 and the separator 101, and it closes the space between the opening surface 91q of the first layer 91 and the separator 101 in a liquid-tight manner.

The gasket 103 is sandwiched by the opening surface 96q of the first layer 96 and the separator 101, and it closes the space between the opening surface 96q of the first layer 96 and the separator 101 in a liquid-tight manner.

### 1.9 Theoretical Voltage of Metal-Air Flow Battery

Through the water oxidation reaction in the positive electrode 93 and the reduction reaction into zinc metal in the negative electrode 98, an overall reaction expressed by Chemical Equation (8) occurs in the charging cell 78.

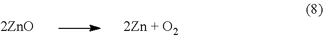

Accordingly, the charging cell 78 changes zinc oxide into zinc metal when charged.

The potentials of the positive and negative electrodes during the discharge and charge reactions stand at −1.25 V and 0.40 V, respectively, with respect to a standard hydrogen electrode. Accordingly, the theoretical voltage of the metal-air flow battery 1 stands at 1.65 V.

### 1.10 Controller

As illustrated in FIG. 1, the controller 26 includes a voltage measuring unit 111 and a control unit 112. The charging unit 25 and the controller 26 constitute a charging system.

The power supply 77 feeds a current I between the positive electrode 93 and the negative electrode 98.

The voltage measuring unit 111 measures a voltage V between the positive electrode 93 and the negative electrode 98. There is no need for direct measurement between the positive electrode 93 and the negative electrode 98; instead, an energization plate having a potential that is substantially equal to that of each of the electrodes may be measured.

The control unit 112 controls the pump 75 to control a flow rate VL of the negative-electrode solution 22 in the second flow channel 96e of the second layer 96. The control unit 112 also controls the power supply 77 to control the current I flowing between the positive electrode 93 and the negative electrode 98.

The control unit 112 controls the flow rate VL in accordance with the voltage V.

The control unit 112 includes a microcontroller and a peripheral circuit. The microcontroller includes a processor and a memory. The processor executes a program stored in the memory, to operate the microcontroller and peripheral circuit as the control unit 112. A process that is executed by the microcontroller may be executed in whole or in part by a dedicated electronic circuit.

### 1.11 Control of Current Value and Flow Rate

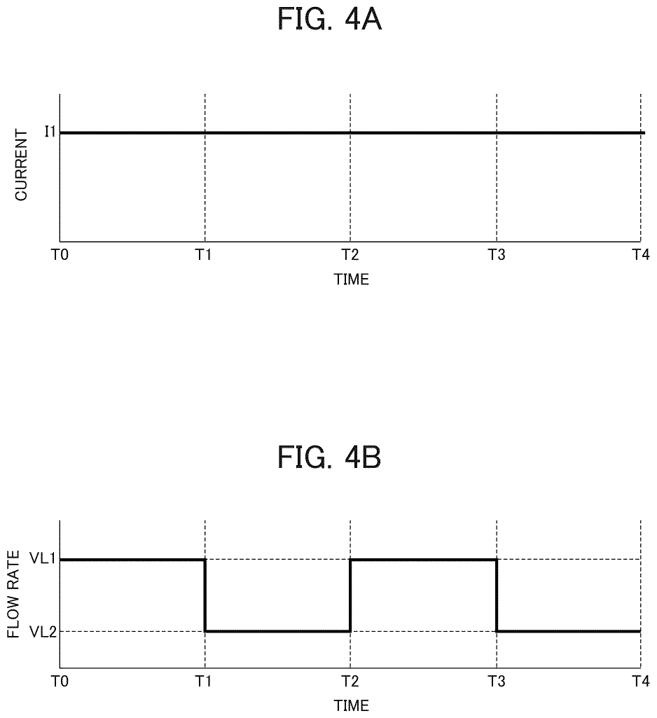

FIG. 4A is a graph showing example time variations in the current flowing between the positive and negative electrodes of the charging cell included in the metal-air flow battery according to the first embodiment. FIG. 4B is a graph showing example time variations in the flow rate of the negative-electrode solution in the second flow channel of the second layer of the charging cell included in the metal-air flow battery according to the first embodiment.

In FIG. 4A, the horizontal axis represents time T, and the vertical axis represents the current I. In FIG. 4B, the horizontal axis represents the time T, and the vertical axis represents the flow rate VL.

As shown in FIG. 4A, the control unit 112 maintains the current I at a constant current I1. The control unit 112 thus sets the current I at the constant current I1 during a time period T0-T4.

As shown in FIG. 4B, the control unit 112 also switches the flow rate VL between a first flow rate VL1 and a second flow rate VL2. The control unit 112 thus sets the flow rate VL at the first flow rate VL1 during a time period T0-T1, sets the flow rate VL at the second flow rate VL2 during a time period T1-T2, sets the flow rate VL at the first flow rate VL1 during a time period T2-T3, and sets the flow rate VL at the second flow rate VL2 during a time period T3-T4. The second flow rate VL2 is lower than the first flow rate VL1.

The first flow rate VL1 is a flow rate at which the negative-electrode active-material ions 42 supplied to the negative electrode 98 become sufficient in number, and at which the negative electrode 98 exhibits a reduction reaction of the negative-electrode active-material ions 42 into the negative-electrode active-material particles 41a in a reduction state, but exhibits no hydrogen generation reaction conflicting the reduction reaction. The second flow rate VL2 is a flow rate at which the negative-electrode active-material ions 42 supplied to the negative electrode 98 become insufficient in number, and at which the negative electrode 98 exhibits no reduction reaction, but exhibits a hydrogen generation reaction.

The hydrogen gas generated through the hydrogen generation reaction adheres to the negative-electrode active-material particles 41a in the reduction state. This increases a buoyant force exerted on the negative-electrode active-material particles 41a in the reduction state. This increases a force exerted on the negative-electrode active-material particles 41a in the reduction state.

Further, the hydrogen gas generated through the hydrogen generation reaction raises the internal pressure of the second flow channel 96e of the second layer 96. This locally increases the flow rate of the negative-electrode solution 97 in the second flow channel 96e. This increases a force exerted on the negative-electrode active-material particles 41a in the reduction state.

This facilitates, upon a hydrogen generation reaction, removing the negative-electrode active-material particles 41a in the reduction state from the negative electrode 98, and discharging the removed negative-electrode active-material particles 41a in the reduction state from the charging cell 78. When a hydrogen sensor in an electrode scheme, a semiconductor hydrogen sensor, a thermoelectric hydrogen sensor, or other types of hydrogen sensors detects hydrogen gas intermittently for 10 seconds or longer at the storage unit 23 or the outlet 78d of the charging cell 78, it may be regarded that hydrogen is generated in the negative electrode for some time. The foregoing hydrogen sensors may be, for instance, hydrogen sensors for alkaline water electrolysis that can be inserted into the space between discharge channels, and the measurement may be made by such a hydrogen sensor inserted into the outlet 78d of the charging cell 78 or the pipe 80.

However, electric power that is used for a hydrogen generation reaction is not used for a reduction reaction. Hence, charging efficiency, which indicates the ratio of electric power consumed for a reduction reaction to electric power consumed by the charging unit 25, is reduced upon occurrence of a hydrogen generation reaction. As such, a hydrogen generation reaction is limited to a minimum extent necessary for removing the negative-electrode active-material particles 41a in the reduction state from the negative electrode 98, and discharging the removed negative-electrode active-material particles 41a in the reduction state from the charging cell 78.

In the time periods T1-T2 and T3-T4, during which a hydrogen generation reaction occurs, the voltage V rises as the hydrogen generation reaction progresses and as time passes.

Based on the voltage V, the control unit 112 controls timings T2 and T4 at which the flow rate VL is switched from the second flow rate VL2 to the first flow rate VL1. The control unit 112 thus changes the durations of the time periods T1-T2 and T3-T4, during which a hydrogen generation reaction occurs, in accordance with the voltage V. This can limit the hydrogen generation reaction to a minimum extent necessary for removing the negative-electrode active-material particles 41a in the reduction state from the negative electrode 98, and discharging the removed negative-electrode active-material particles 41a in the reduction state from the charging cell 78. This can enhance the charging efficiency.

The control unit 112 switches the flow rate VL from the second flow rate VL2 to the first flow rate VL1 in response to a rise ratio ΔV of the voltage V exceeding an established rise ratio ΔVs.

In the time periods T1-T2 and T3-T4, during which a hydrogen generation reaction occurs, the voltage V strongly depends on the current I, but the rise ratio ΔV of the voltage V does not strongly depend on the current I. As such, switching the flow rate VL in response to the rise ratio ΔV of the voltage V exceeding the established rise ratio ΔVs rather than in response to the voltage V exceeding an established voltage can bring the timings T2 and T4, at which the flow rate VL is switched, into proper timings irrespective of the current I.

When the durations of the time periods T1-T2 and T3-T4, during which a hydrogen generation reaction occurs, are longer than a proper duration, the amount of hydrogen gas generated through the hydrogen generation reaction is larger than a proper amount. Hence, the generated hydrogen gas remains in the second flow channel 96e of the second layer 96. This causes no-liquid heating, in which the voltage V reaches an abnormal value. When the durations of the time periods T1-T2 and T3-T4, during which a hydrogen generation reaction occurs, are shorter than the proper duration, the amount of hydrogen gas generated through the hydrogen generation reaction is smaller than a proper amount. This makes it difficult to remove the negative-electrode active-material particles 41a in the reduction state from the negative electrode 98, and discharge the removed negative-electrode active-material particles 41a in the reduction state from the charging cell 78. This leads to a possibility that the second flow channel 96e may be clogged with the negative-electrode active-material particles 41a in the reduction state. Accordingly, the established time rise ratio ΔVs, which is compared with the time rise ratio ΔV of the voltage V, is set such that the durations of the time periods T1-T2 and T3-T4, during which a hydrogen generation reaction occurs, are proper; for instance, the established time rise ratio ΔVs is set at 1.35 V/s.

In the first embodiment, the current I is maintained at the constant current I1 during the time period T0-T4. However, the current I may be fluctuated during the time period T0-T4 within a range in which the current I is equal to or larger than a specific current. Also in the first embodiment, the flow rate VL is maintained at the constant, first flow rate VL1 during the time periods T0-T1 and T2-T3, and maintained at the constant, second flow rate VL2 during the time periods T1-T2 and T3-T4. However, the flow rate VL may be fluctuated during the time periods T0-T1 and T2-T3 within a range in which the flow rate VL is equal to or higher than the first flow rate VL1, and fluctuated during the time periods of T1 to T2 and T3 to T4 within a range in which the flow rate VL is equal to or lower than the second flow rate VL2.

The charging system according to the first embodiment includes a single charging cell 78. However, the charging system may include a stack of a plurality of charging cells 78 electrically connected in series. When the charging system includes such a stack, the voltage measuring unit 111 measures the entire voltage V of the stack and returns the value of a voltage V/n obtained by dividing the measured voltage V by the number, n, of the plurality of charging cells 78. Based on the value of the voltage V/n, the control unit 112 controls the timings T2 and T4, at which the flow rate VL is switched from the second flow rate VL2 to the first flow rate VL1.

### 1.12 Process Flow

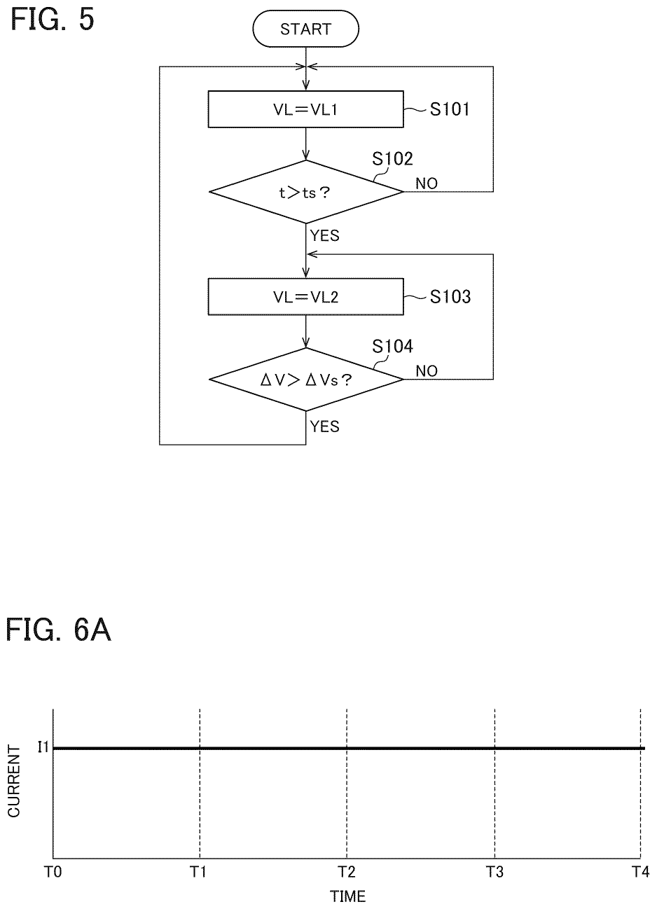

FIG. 5 is a flowchart showing a process that is performed by the control unit included in the metal-air flow battery according to the first embodiment.

The control unit 112 executes steps S101 to S104 shown in FIG. 5.

In Step S101, the control unit 112 sets the flow rate VL at the first flow rate VL1. Accordingly, the negative-electrode active-material ions 42 supplied to the negative electrode 98 become sufficient in number. Accordingly, a reduction reaction of the negative-electrode active-material ions 42 into the negative-electrode active-material particles 41a in a reduction state occurs in the negative electrode 98. The negative-electrode active-material particles 41a in the reduction state thus adhere to the negative electrode 98 and grow.

In subsequent Step S102, the control unit 112 determines whether a time t elapsed from when the flow rate VL is set at the first flow rate VL1 is longer than an established time ts. If determining that the time t is longer than the established time ts, the control unit 112 executes Step S103. If determining that the time t is shorter than the established time ts, the control unit 112 executes Step S101.

Through Steps S101 and S102, the flow rate VL remains at the first flow rate VL1 until the established time ts elapses from when the flow rate VL is set at the first flow rate VL1. Further, the state in which the flow rate VL remains at the first flow rate VL1 ends in synchronization with a lapse of the established time ts from when the flow rate VL is set at the first flow rate VL1.

In Step S103, the control unit 112 sets the flow rate VL at the second flow rate VL2. Accordingly, the negative-electrode active-material ions 42 supplied to the negative electrode 98 become insufficient in number. Accordingly, a hydrogen generation reaction occurs in the negative electrode 98. This removes the negative-electrode active-material particles 41a in the reduction state adhering to the negative electrode 98.

In subsequent Step S104, the control unit 112 determines whether the rise ratio ΔV of the voltage V is larger than the established rise ratio ΔVs. If determining that the rise ratio ΔV of the voltage V is larger than the established rise ratio ΔVs, the control unit 112 executes Step S101. If determining that the rise ratio ΔV of the voltage V is smaller than the established rise ratio ΔVs, the control unit 112 executes Step S103.

Through Steps S103 and S104, the flow rate VL remains at the second flow rate VL2 until the rise ratio ΔV of the voltage V reaches the established rise ratio ΔVs. Further, the state in which the flow rate VL remains at the second flow rate VL2 ends in synchronization with the rise ratio ΔV of the voltage V reached the established rise ratio ΔVs.

Through Steps S101 to S104, the flow rate VL is switched between the first flow rate VL1 and the second flow rate VL2. Further, the time during which the flow rate VL remains at the first flow rate VL1 is the established time ts. Further, the time during which the flow rate VL remains at the second flow rate VL2 is a variable time, which changes depending on the progress of the hydrogen generation reaction.

### 1.13 Modifications

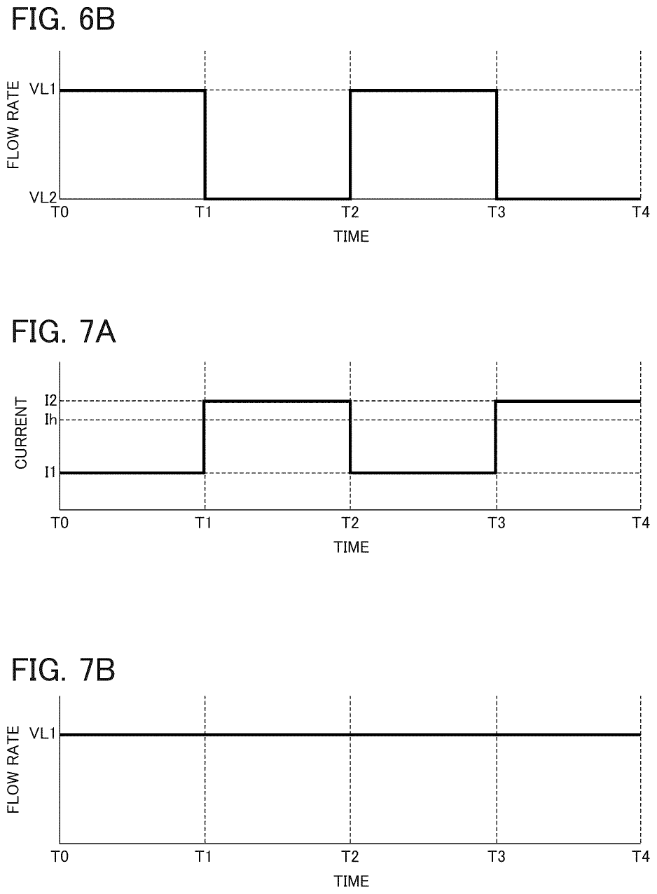

FIG. 6A is a graph showing example time variations in the current flowing between the positive and negative electrodes of the charging cell included in the metal-air flow battery according to a first modification of the first embodiment. FIG. 6B is a graph showing example time variations in the flow rate of the negative-electrode solution in the second flow channel of the second layer of the charging cell included in the metal-air flow battery according to the first modification of the first embodiment.

In FIG. 6A, the horizontal axis represents the time T, and the vertical axis represents the current I. In FIG. 6B, the horizontal axis represents the time T, and the vertical axis represents the flow rate VL.

In the first embodiment, the second flow rate VL2 is larger than zero, as shown in FIG. 4B. The control unit 112 thus turns on the pump 75 to cause the pump 75 to generate a flow of the negative-electrode solution 22 even while the flow rate VL remains at the second flow rate VL2.

In the first modification of the first embodiment by contrast, the second flow rate VL2 stands at zero, as shown in FIG. 6B. If a deviation within ±0.5 lasts for 5.0 seconds, the second flow rate VL2 is considered to stand at zero. The control unit 112 thus turns off the pump 75 to cause the pump 75 not to generate a flow of the negative-electrode solution 22 while the flow rate VL remains at the second flow rate VL2. The control unit 112 thus switches the flow rate VL between the first flow rate VL1 and the second flow rate VL2 by switching the pump 75 between ON and OFF. At the second flow rate VL2 that stands at zero, the durations of the time periods T1-T2 and T3-T4, during which a hydrogen generation reaction occurs, can be shorter than those at the second flow rate VL2 that is larger than zero, so that electric power consumed by the pump 75 and other auxiliary equipment can be reduced. The flow rate of the pump 75 depends on voltage that is input to the pump 75, and VL1, VL2, and 0 (meaning that the pump is off) are controlled by outputting a signal from a microcomputer. As such, the voltage on the INPUT side of the pump 75 is monitored, and when the voltage on the INPUT side stands at 0 V, it may be regarded that the flow rate stands at zero. When the deviation exceeds a threshold by only 0.01 for 0.01 seconds, the deviation is regarded as exceeding the threshold.

### 2 Second Embodiment

The following describes a point in which the second embodiment is different from the first embodiment. With regard to what will not be described, a configuration similar to the configuration adopted in the first embodiment will be adopted in the second embodiment as well.

In the second embodiment, the control unit 112 controls a current I in accordance with a voltage V.

FIG. 7A is a graph showing example time variations in the current flowing between the positive and negative electrodes of the charging cell included in the metal-air flow battery according to the second embodiment. FIG. 7B is a graph showing example time variations in the flow rate of the negative-electrode solution in the second flow channel of the second layer of the charging cell included in the metal-air flow battery according to the second embodiment.

In FIG. 7A, the horizontal axis represents time T, and the vertical axis represents the current I. In FIG. 7B, the horizontal axis represents the time T, and the vertical axis represents a flow rate VL.

In the second embodiment, the control unit 112 switches the current I between a first current I1 and a second current I2, as shown in FIG. 7A. The control unit 112 thus sets the current I at the first current I1 during a time period T0-T1, sets the current I at the second current I2 during a time period T1-T2, sets the current I at the first current I1 during a time period T2-T3, and sets the current I at the second current I2 during a time period T3-T4. The second current I2 is larger than the first current I1.

As shown in FIG. 7B, the control unit 112 also maintains the flow rate VL at a constant flow rate VL1. The control unit 112 thus sets the flow rate VL at the constant flow rate VL1 during a time period T0-T4.

The first current I1 is a current that is smaller than a current Ih at which a hydrogen generation reaction starts occurring, and is a current at which the negative electrode 98 exhibits a reduction reaction of the negative-electrode active-material ions 42 into the negative-electrode active-material particles 41a in a reduction state, but exhibits no hydrogen generation reaction conflicting the reduction reaction. The second current I2 is a current that is larger than the current Ih, and at which the negative electrode 98 exhibits no reduction reaction, but exhibits a hydrogen generation reaction.

Based on the voltage V, the control unit 112 controls timings T2 and T4 at which the current I is switched from the second current I2 to the first current I1. The control unit 112 thus changes the durations of the time periods T1-T2 and T3-T4, during which a hydrogen generation reaction occurs, in accordance with the voltage V. This can limit the hydrogen generation reaction to a minimum extent necessary for removing the negative-electrode active-material particles 41a in the reduction state from the negative electrode 98, and discharging the removed negative-electrode active-material particles 41a in the reduction state from the charging cell 78. This can enhance charging efficiency.

The control unit 112 switches the current I from the second current I2 to the first current I1 in response to, for instance, a rise ratio ΔV of the voltage V exceeding an established rise ratio ΔVs.

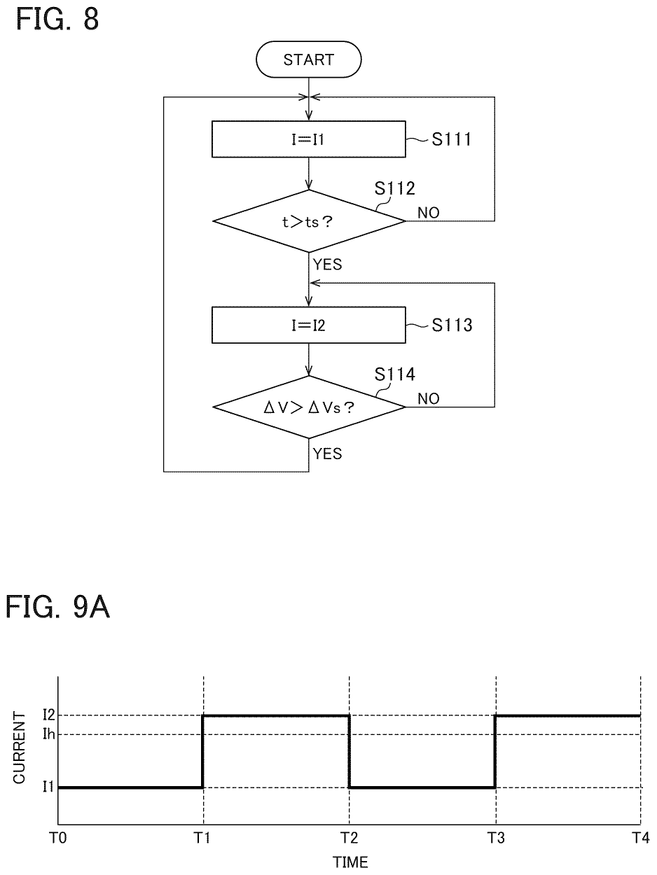

FIG. 8 is a flowchart showing a process that is performed by the control unit included in the metal-air flow battery according to the second embodiment.

In the second embodiment, the control unit 112 executes Steps S111 to S114 shown in FIG. 8.

In Step S111, the control unit 112 sets the current I at the first current I1. Accordingly, a reduction reaction of the negative-electrode active-material ions 42 into the negative-electrode active-material particles 41a in a reduction state occurs in the negative electrode 98. The negative-electrode active-material particles 41a in the reduction state thus adhere to the negative electrode 98 and grow.

In subsequent Step S112, the control unit 112 determines whether a time t elapsed from when the current I is set at the first current I1 is longer than an established time ts. If determining that the time t is longer than the established time ts, the control unit 112 executes Step S113. If determining that the time t is shorter than the established time ts, the control unit 112 executes Step S111.

Through Steps S111 and S112, the current I remains at the first current I1 until the established time ts elapses from when the current I is set at the first current I1. Further, the state in which the current I remains at the first current I1 ends in synchronization with a lapse of the established time ts from when the current I is set at the first current I1.

In Step S113, the control unit 112 sets the current I at the second current I2. Accordingly, a hydrogen generation reaction occurs in the negative electrode 98. This removes the negative-electrode active-material particles 41a in the reduction state adhering to the negative electrode 98.

In subsequent Step S114, the control unit 112 determines whether the rise ratio ΔV of the voltage V is larger than the established rise ratio ΔVs. If determining that the rise ratio ΔV of the voltage V is larger than the established rise ratio ΔVs, the control unit 112 executes Step S111. If determining that the rise ratio ΔV of the voltage V is smaller than the established rise ratio ΔVs, the control unit 112 executes Step S113.

Through Steps S113 and S114, the current I remains at the second current I2 until the rise ratio ΔV of the voltage V reaches the established rise ratio ΔVs. Further, the state in which the current I remains at the second current I2 ends in synchronization with the rise ratio ΔV of the voltage V reached the established rise ratio ΔVs.

Through Steps S111 to S114, the current I is switched between the first current I1 and the second current I2. Further, the time during which the current I is set at the first current I1 is the established time ts. Further, the time during which the current I is set at the second current I2 is a variable time, which changes depending on the progress of the hydrogen generation reaction.

### 3 Third Embodiment

The following describes a point in which the third embodiment is different from the first embodiment. With regard to what will not be described, a configuration similar to the configuration adopted in the first embodiment will be adopted in the third embodiment as well.

In the third embodiment, the control unit 112 controls a current I and a flow rate VL in accordance with a voltage V.

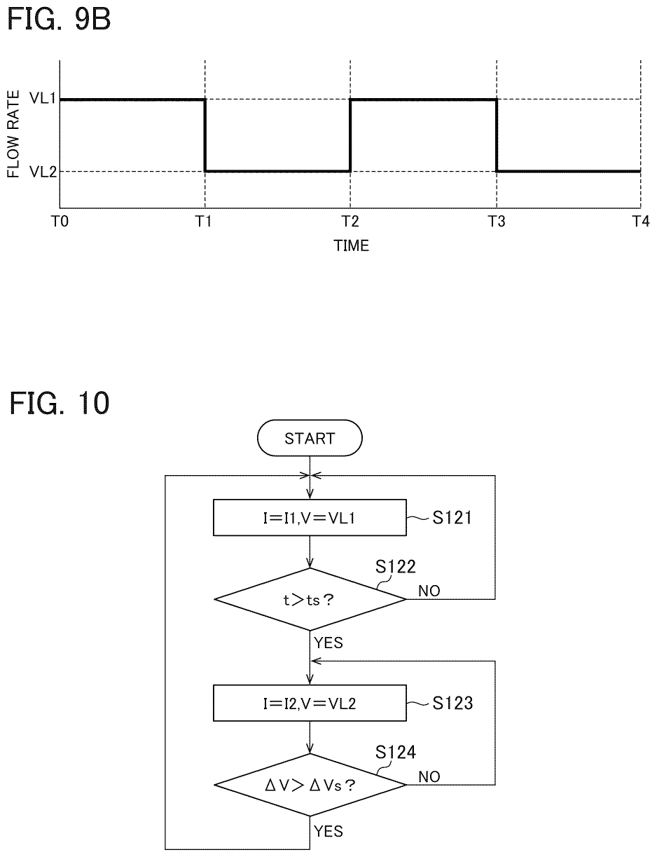

FIG. 9A is a graph showing example time variations in the current flowing between the positive and negative electrodes of the charging cell included in the metal-air flow battery according to the third embodiment. FIG. 9B is a graph showing example time variations in the flow rate of the negative-electrode solution in the second flow channel of the second layer of the charging cell included in the metal-air flow battery according to the third embodiment.

In FIG. 9A, the horizontal axis represents time T, and the vertical axis represents the current I. In FIG. 9B, the horizontal axis represents the time T, and the vertical axis represents the flow rate VL.

In the third embodiment, the control unit 112 switches the current I between a first current I1 and a second current I2, as shown in FIG. 9A. The control unit 112 thus sets the current I at the first current I1 during a time period T0-T1, sets the current I at the second current I2 during a time period T1-T2, sets the current I at the first current I1 during a time period T2-T3, and sets the current I at the second current I2 during a time period T3-T4. The second current I2 is larger than the first current I1.

As shown in FIG. 9B, the control unit 112 also switches the flow rate VL between a first flow rate VL1 and a second flow rate VL2. The control unit 112 thus sets the flow rate VL at the first flow rate VL1 during the time period T0-T1, sets the flow rate VL at the second flow rate VL2 during the time period T1-T2, sets the flow rate VL at the first flow rate VL1 during the time period T2-T3, and sets the flow rate VL at the second flow rate VL2 during the time period T3-T4. The second flow rate VL2 is lower than the first flow rate VL1.

The first current I1 is a current that is smaller than a current Ih at which a hydrogen generation reaction starts occurring, and is a current at which the negative electrode 98 exhibits a reduction reaction of the negative-electrode active-material ions 42 into the negative-electrode active-material particles 41a in a reduction state, but exhibits no hydrogen generation reaction conflicting the reduction reaction. The second current I2 is a current that is larger than the current Ih, and at which the negative electrode 98 exhibits no reduction reaction, but exhibits a hydrogen generation reaction.

The first flow rate VL1 is a flow rate at which the negative-electrode active-material ions 42 supplied to the negative electrode 98 become sufficient in number, and at which the negative electrode 98 exhibits a reduction reaction of the negative-electrode active-material ions 42 into the negative-electrode active-material particles 41a in a reduction state, but exhibits no hydrogen generation reaction conflicting the reduction reaction. The second flow rate VL2 is a flow rate at which the negative-electrode active-material ions 42 supplied to the negative electrode 98 become insufficient in number, and at which the negative electrode 98 exhibits no reduction reaction and exhibits a hydrogen generation reaction.

A larger amount of hydrogen is generated in a short time in response to the current I switched to the second current I2, and to the flow rate VL switched to the second flow rate VL2, than that in the following cases: in response to the current I switched to the second current I2, and to the flow rate VL maintained at the first flow rate VL1; and in response to the current I maintained at the first current I1, and to the flow rate VL switched to the second flow rate VL2. In such a case where a large amount of hydrogen is generated in a short time, it is easier to remove the negative-electrode active-material particles 41a in the reduction state from the negative electrode 98, and to discharge the removed negative-electrode active-material particles 41a in the reduction state from the charging cell 78. This can further enhance charging efficiency.

Based on the voltage V, the control unit 112 controls timings T2 and T4 at which the flow rate VL and the current I are switched from the second flow rate VL2 as well as the second current I2 to the first flow rate VL1 as well as the first current I1. The control unit 112 thus changes the durations of the time periods T1-T2 and T3-T4, during which a hydrogen generation reaction occurs, in accordance with the voltage V. This can limit the hydrogen generation reaction to a minimum extent necessary for removing the negative-electrode active-material particles 41a in the reduction state from the negative electrode 98, and discharging the removed negative-electrode active-material particles 41a in the reduction state from the charging cell 78. This can enhance charging efficiency.

The control unit 112 switches the flow rate VL and the current I from the second flow rate VL2 as well as the second current I2 to the first flow rate VL1 as well as the first current I1 in response to a rise ratio ΔV of the voltage V exceeding an established rise ratio ΔVs.

FIG. 10 is a flowchart showing a process that is performed by the control unit included in the metal-air flow battery according to the third embodiment.

In the third embodiment, the control unit 112 executes Steps S121 to S124 shown in FIG. 10.

In Step S121, the control unit 112 sets the current I at the first current I1 and sets the flow rate VL at the first flow rate VL1. Accordingly, a reduction reaction of the negative-electrode active-material ions 42 into the negative-electrode active-material particles 41a in a reduction state occurs in the negative electrode 98. The negative-electrode active-material particles 41a in the reduction state thus adhere to the negative electrode 98 and grow. The charging unit 25 consumes the smallest electric power in a time period during which the current I remains at the first current I1, and during which the flow rate VL remains at the first flow rate VL1.

In subsequent Step S122, the control unit 112 determines whether a time t elapsed from when the current I is set at the first current I1, and the flow rate VL is set at the first flow rate VL1 is longer than an established time ts. If determining that the time t is longer than the established time ts, the control unit 112 executes Step S123. If determining that the time t is shorter than the established time ts, the control unit 112 executes Step S121.

Through Steps S121 and S122, the current I remains at the first current I1, and the flow rate VL remains at the first flow rate VL1 until the established time ts elapses from when the current I is set at the first current I1, and the flow rate VL is set at the first flow rate VL1. Further, the state in which the current I remains at the first current I1, and the flow rate VL is set at the first flow rate VL1 ends in synchronization with a lapse of the established time ts from when the current I is set at the first current I1, and the flow rate VL is set at the first flow rate VL1.

In Step S123, the control unit 112 sets the current I at the second current I2 and sets the flow rate VL at the second flow rate VL2. Accordingly, a hydrogen generation reaction occurs in the negative electrode 98. This removes the negative-electrode active-material particles 41a in the reduction state adhering to the negative electrode 98.

In subsequent Step S124, the control unit 112 determines whether the rise ratio ΔV of the voltage V is larger than the established rise ratio ΔVs. If determining that the rise ratio ΔV of the voltage V is larger than the established rise ratio ΔVs, the control unit 112 executes Step S121. If determining that the rise ratio ΔV of the voltage V is smaller than the established rise ratio ΔVs, the control unit 112 executes Step S123.

Through Steps S123 and S124, the current I remains at the second current I2, and the flow rate VL remains at the second flow rate VL2 until the rise ratio ΔV of the voltage V reaches the established rise ratio ΔVs. Further, the state in which the current I remains at the second current I2, and the flow rate VL remains at the second flow rate VL2 ends in synchronization with the rise ratio ΔV of the voltage V reached the established rise ratio ΔVs.

Through Steps S121 to S124, the current I and the flow rate VL are switched between the first current I1 as well as the first flow rate VL1 and the second current I2 as well as the second flow rate VL2. Further, the time during which the current I and the flow rate VL are set at the first current I1 and the first flow rate VL1, respectively, is the established time ts. Further, the time during which the current I and the flow rate VL are set at the second current I2 and the second flow rate VL2, respectively, is a variable time, which changes depending on the progress of the hydrogen generation reaction.

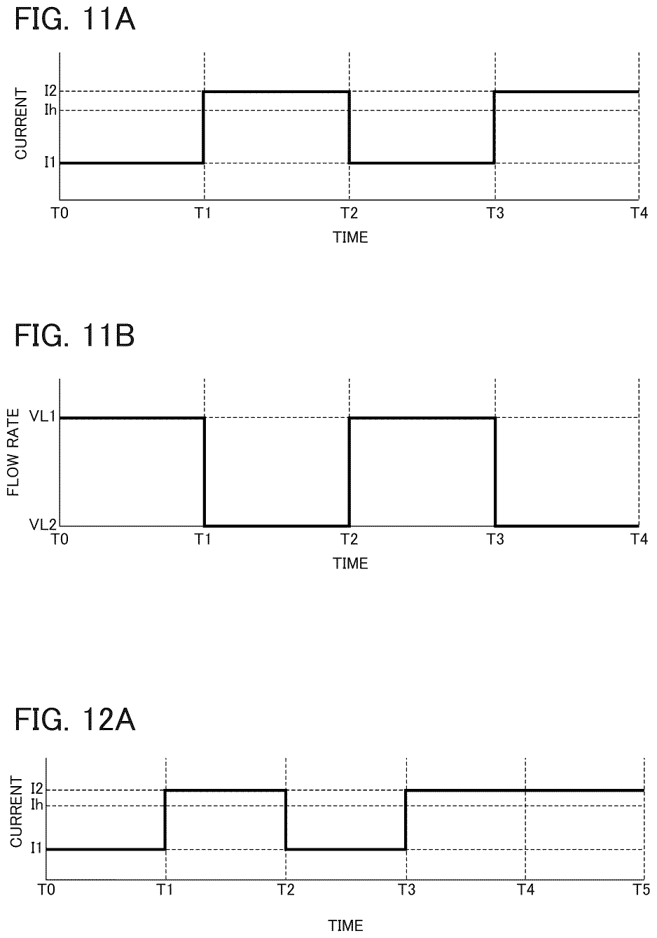

FIG. 11A is a graph showing example time variations in the current flowing between the positive and negative electrodes of the charging cell included in the metal-air flow battery according to a first modification of the third embodiment. FIG. 11B is a graph showing example time variations in the flow rate of the negative-electrode solution in the second flow channel of the second layer of the charging cell included in the metal-air flow battery according to the first modification of the third embodiment.

In FIG. 11A, the horizontal axis represents the time T, and the vertical axis represents the current I. In FIG. 11B, the horizontal axis represents the time T, and the vertical axis represents the flow rate VL.

In the third embodiment, the second flow rate VL2 is larger than zero, as shown in FIG. 9B. The control unit 112 thus turns on the pump 75 to cause the pump 75 to generate a flow of the negative-electrode solution 22 even while the flow rate VL remains at the second flow rate VL2.

In the first modification of the third embodiment by contrast, the second flow rate VL2 stands at zero, as shown in FIG. 11B. The control unit 112 thus turns off the pump 75 to cause the pump 75 not to generate a flow of the negative-electrode solution 22 while the flow rate VL remains at the second flow rate VL2. The control unit 112 thus switches the flow rate VL between the first flow rate VL1 and the second flow rate VL2 by switching the pump 75 between ON and OFF. At the second flow rate VL2 that stands at zero, the durations of the time periods T1-T2 and T3-T4, during which a hydrogen generation reaction occurs, can be shorter than those at the second flow rate VL2 that is larger than zero, so that electric power consumed by the pump 75 and other auxiliary equipment can be reduced.

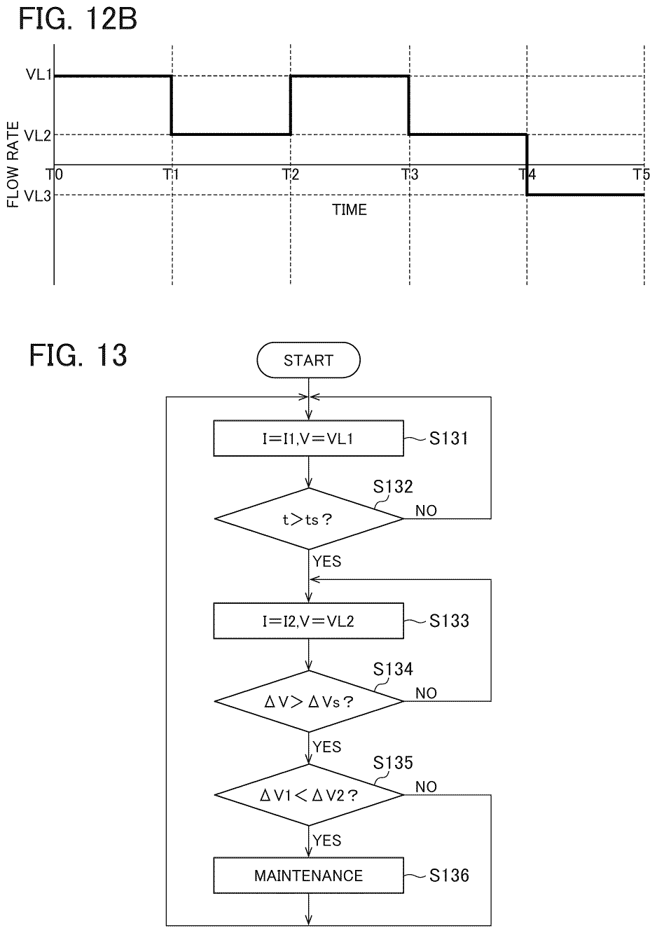

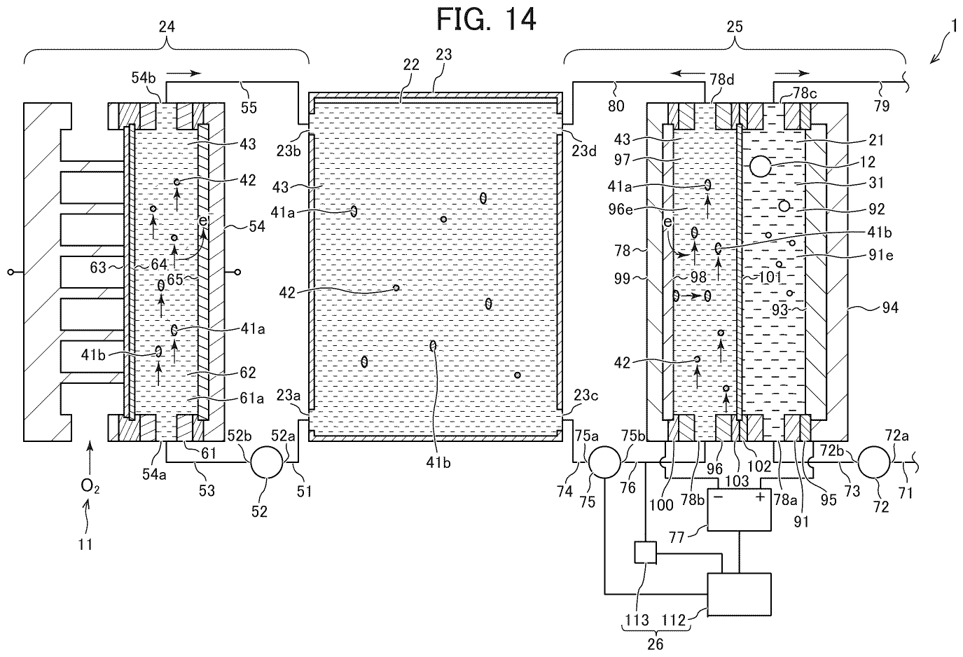

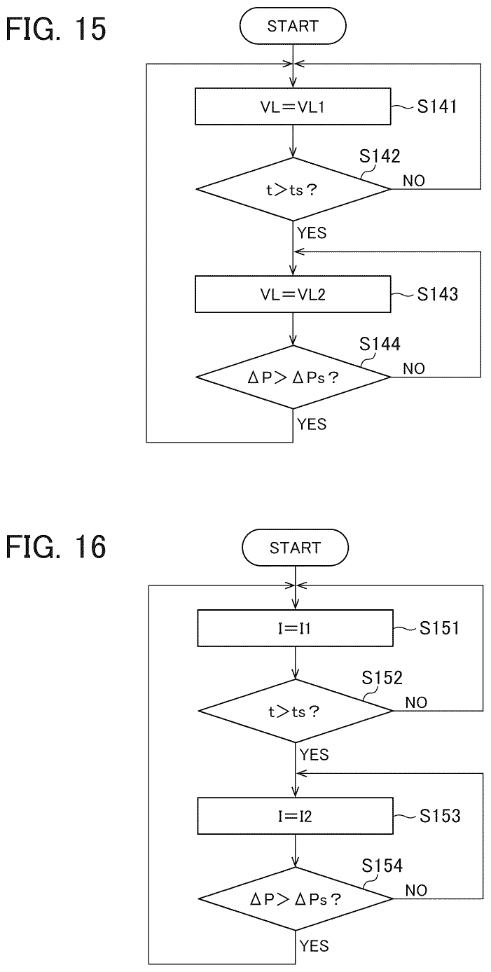

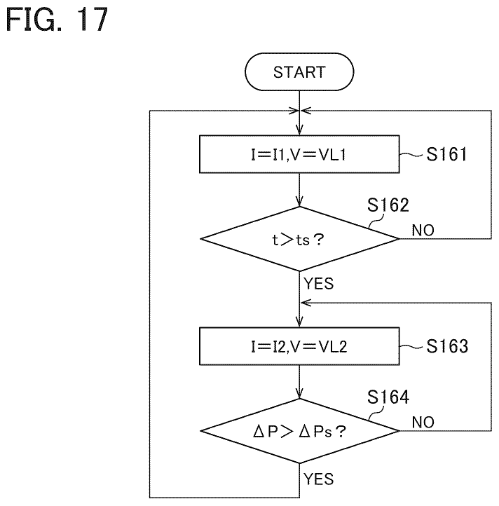

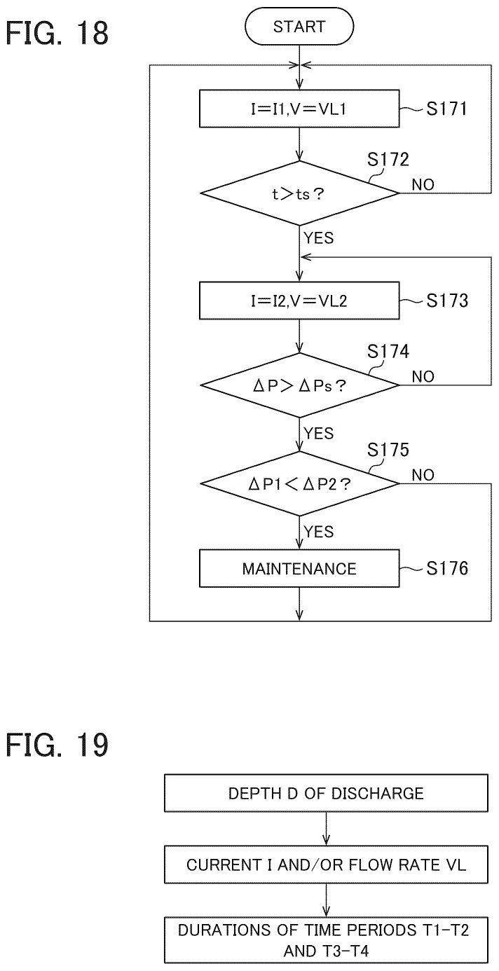

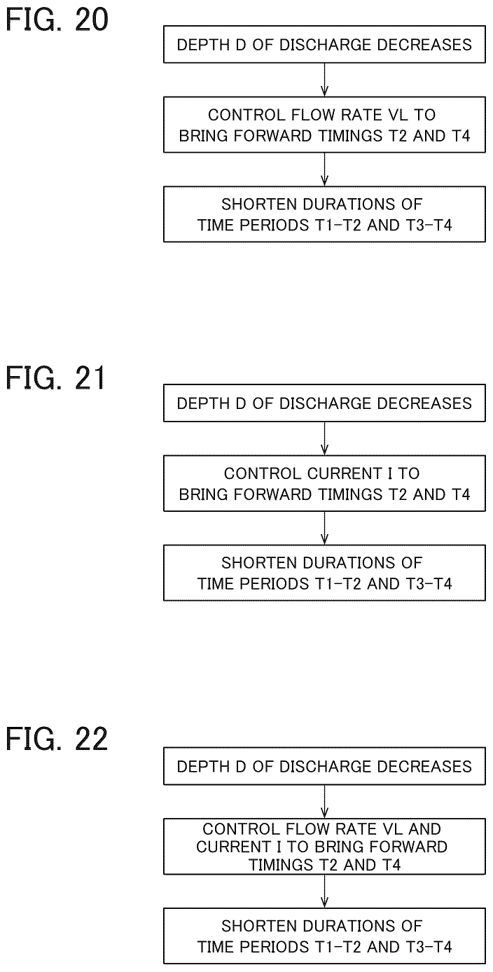

FIG. 12A is a graph showing example time variations in the current flowing between the positive and negative electrodes of the charging cell included in the metal-air flow battery according to a second modification of the third embodiment. FIG. 12B is a graph showing example time variations in the flow rate of the negative-electrode solution in the second flow channel of the second layer of the charging cell included in the metal-air flow battery according to the second modification of the third embodiment.

In FIG. 12A, the horizontal axis represents the time T, and the vertical axis represents the current I. In FIG. 12B, the horizontal axis represents the time T, and the vertical axis represents the flow rate VL.

In the second modification of the third embodiment, when a rise ratio ΔV1 of the voltage V in the time period T3-T4, during which a hydrogen generation reaction occurs this time, is not lower than a rise ratio ΔV2 of the voltage V in the time period T1-T2, during which a hydrogen generation reaction occurred the last time, the control unit 112 continues, even on or after the timing T4, switching the current I and the flow rate VL between the first current I1 as well as the first flow rate VL1 and the second current I2 as well as the second flow rate VL2.

However, when the rise ratio ΔV1 of the voltage V in the time period T3-T4, during which a hydrogen generation reaction occurs this time, is lower than the rise ratio ΔV2 of the voltage V in the time period T1-T2, during which a hydrogen generation reaction occurred the last time, the control unit 112 performs maintenance in a subsequent time period T4-T5. When starting the maintenance, the control unit 112 maintains the current I at the second current I2, as shown in FIG. 12A, and switches the flow rate VL from the second flow rate VL2 to a third flow rate VL3, as shown in FIG. 12B. The third flow rate VL3 has a sign opposite to the sign of the second flow rate VL2. The third flow rate VL3 may have the same absolute value as the absolute value of the second flow rate VL2, or have an absolute value different from the absolute value of the second flow rate VL2.

A hydrogen generation reaction occurs during the maintenance. This facilitates removing the negative-electrode active-material particles 41a in the reduction state from the negative electrode 98, and discharging the removed negative-electrode active-material particles 41a in the reduction state from the charging cell 78.

In addition, the negative-electrode solution 97 flows through the second flow channel 96e of the second layer 96 in a reverse direction during the maintenance. Accordingly, a force having a direction opposite to the direction of a force exerted on the negative-electrode active-material particles 41a in the reduction state before the maintenance is exerted on the negative-electrode active-material particles 41a in the reduction state. This further facilitates removing the negative-electrode active-material particles 41a in the reduction state from the negative electrode 98, and discharging the removed negative-electrode active-material particles 41a in the reduction state from the charging cell 78.

The negative-electrode active-material particles 41a in the reduction state grow along the direction of flow of the negative-electrode solution 97. The negative-electrode active-material particles 41a in the reduction state thus continues growing along the direction of flow of the negative-electrode solution 97 when the direction is constant. The negative-electrode active-material particles 41a in the reduction state can prevent itself from continuing growing along the direction of flow of the negative-electrode solution 97 when the direction is not constant. This further facilitates removing the negative-electrode active-material particles 41a in the reduction state from the negative electrode 98 when a force having an opposite direction is exerted on the negative-electrode active-material particles 41a in the reduction state.

FIG. 13 is a flowchart showing a process that is performed by the control unit included in the metal-air flow battery according to the second modification of the third embodiment.

In the second modification of the third embodiment, the control unit 112 executes Steps S131 to S136 shown in FIG. 13.

In Steps S131 to S133, process steps similar to those performed in Steps S121 to S123 shown in FIG. 10 are performed.

In subsequent Step S134, the control unit 112 determines whether the rise ratio ΔV of the voltage V is larger than the established rise ratio ΔVs. If determining that the rise ratio ΔV of the voltage V is larger than the established rise ratio ΔVs, the control unit 112 executes Step S135. If determining that the rise ratio ΔV of the voltage V is smaller than the established rise ratio ΔVs, the control unit 112 executes Step S133.

In Step S135, the control unit 112 determines whether the rise ratio ΔV1 of the voltage V in a time period during which the current I and the flow rate VL are set at the second current I2 and the second flow rate VL2, respectively, this time is smaller than the rise ratio ΔV2 of the voltage V in a time period during which the current I and the flow rate VL were set at the second current I2 and the second flow rate VL2, respectively, the last time. If determining that the rise ratio ΔV1 of the voltage V is smaller than the rise ratio ΔV2 of the voltage V, the control unit 112 executes Step S136, followed by Step S131. If determining that the rise ratio ΔV1 of the voltage V is not smaller than the rise ratio ΔV2 of the voltage V, the control unit 112 executes Step S131 without executing Step S136.

In Step S136, the control unit 112 performs maintenance.

Through Steps S135 and S136, the control unit 112 continues alternating switching of the current I and flow rate VL without performing maintenance when the rise ratio ΔV1 of the voltage V is not smaller than the rise ratio ΔV2 of the voltage V, and it restarts the alternating switching of the current I and flow rate VL after performing the maintenance when the rise ratio ΔV1 of the voltage V is smaller than the rise ratio ΔV2 of the voltage V. The control unit 112 may perform maintenance when the voltage V satisfies a condition other than the condition in which the rise ratio ΔV1 of the voltage V is smaller than the rise ratio ΔV2 of the voltage V.

### 4 Fourth Embodiment

The following describes a point in which the fourth embodiment is different from the first embodiment. With regard to what will not be described, a configuration similar to the configuration adopted in the first embodiment will be adopted in the fourth embodiment as well.

FIG. 14 schematically illustrates the metal-air flow battery according to the fourth embodiment.

In the fourth embodiment, the controller 26 includes a pressure gauging unit 113 and the control unit 112, as illustrated in FIG. 14. The pressure gauging unit 113 and the control unit 112 constitute a charging system.

The pressure gauging unit 113 is connected to the pipe 76 and measures a feeding pressure P of the negative-electrode solution 22 led by the pipe 76. The measured feeding pressure P indicates a pressure exerted on the second flow channel 96e of the second layer 96.

In the fourth embodiment, the control unit 112 controls the flow rate VL in accordance with the feeding pressure P.

FIG. 4A is also a graph showing example time variations in the current flowing between the positive and negative electrodes of the charging cell included in the metal-air flow battery according to the fourth embodiment. FIG. 4B is also a graph showing example time variations in the flow rate of the negative-electrode solution in the second flow channel of the second layer of the charging cell included in the metal-air flow battery according to the fourth embodiment.

In the fourth embodiment, the control unit 112 maintains a current I at a constant current I1, as shown in FIG. 4A.

As shown in FIG. 4B, the control unit 112 also switches the flow rate VL between a first flow rate VL1 and a second flow rate VL2. The second flow rate VL2 is lower than the first flow rate VL1.

The first flow rate VL1 is a flow rate at which the negative electrode 98 exhibits a reduction reaction of the negative-electrode active-material ions 42 into the negative-electrode active-material particles 41a in a reduction state, but exhibits no hydrogen generation reaction conflicting the reduction reaction. The second flow rate VL2 is a flow rate at which the negative electrode 98 exhibits no reduction reaction, but exhibits a hydrogen generation reaction.

In the time periods T1-T2 and T3-T4, during which a hydrogen generation reaction occurs, the feeding pressure P increases as the hydrogen generation reaction progresses and as time passes.

In the fourth embodiment, the control unit 112 controls, in accordance with the feeding pressure P, the timings T2 and T4, at which the flow rate VL is switched from the second flow rate VL2 to the first flow rate VL1. This can limit the hydrogen generation reaction to a minimum extent necessary for removing the negative-electrode active-material particles 41a in the reduction state from the negative electrode 98, and discharging the removed negative-electrode active-material particles 41a in the reduction state from the charging cell 78. This can enhance charging efficiency.

The control unit 112 switches the flow rate VL from the second flow rate VL2 to the first flow rate VL1 in response to a rise ratio ΔP of the feeding pressure P exceeding an established rise ratio ΔPs.

The established time rise ratio ΔPs, which is compared with the time rise ratio ΔP of the feeding pressure P, is set such that the time periods T1-T2 and T3-T4, during which a hydrogen generation reaction occurs, are proper; for instance, the established time rise ratio ΔPs is set at 10.4 kPa/s.

FIG. 15 is a flowchart showing a process that is performed by the control unit included in the metal-air flow battery according to the fourth embodiment.

The control unit 112 executes Steps S141 to S144 shown in FIG. 15.

In Steps S141 to S143, process steps similar to those performed in Steps S101 to S103 shown in FIG. 5 are performed.

In subsequent Step S144, the control unit 112 determines whether the rise ratio ΔP of the feeding pressure P is larger than the established rise ratio ΔPs. If determining that the rise ratio ΔP of the feeding pressure P is larger than the established rise ratio ΔPs, the control unit 112 executes Step S141. If determining that the rise ratio ΔP of the feeding pressure P is smaller than the established rise ratio ΔPs, the control unit 112 executes Step S143.

Through Steps S143 and S144, the flow rate VL remains at the second flow rate VL2 until the rise ratio ΔP of the feeding pressure P reaches the established rise ratio ΔPs. Further, the state in which the flow rate VL remains at the second flow rate VL2 ends in synchronization with the rise ratio ΔP of the feeding pressure P reached the established rise ratio ΔPs.

FIG. 6A is also a graph showing example time variations in the current flowing between the positive and negative electrodes of the charging cell included in the metal-air flow battery according to a first modification of the fourth embodiment. FIG. 6B is also a graph showing example time variations in the flow rate of the negative-electrode solution in the second flow channel of the second layer of the charging cell included in the metal-air flow battery according to the first modification of the fourth embodiment.

In the first modification of the fourth embodiment, the second flow rate VL2 stands at zero, as shown in FIG. 6B. At the second flow rate VL2 that stands at zero, the durations of the time periods T1-T2 and T3-T4, during which a hydrogen generation reaction occurs, can be shorter than those at the second flow rate VL2 that is larger than zero, so that electric power consumed by the pump 75 and other auxiliary equipment can be reduced.

### 5 Fifth Embodiment

The following describes a point in which the fifth embodiment is different from the fourth embodiment. With regard to what will not be described, a configuration similar to the configuration adopted in the fourth embodiment will be adopted in the fifth embodiment as well.

In the fifth embodiment, the control unit 112 controls a current I in accordance with a feeding pressure P.

FIG. 7A is also a graph showing example time variations in the current flowing between the positive and negative electrodes of the charging cell included in the metal-air flow battery according to the fifth embodiment. FIG. 7B is also a graph showing example time variations in the flow rate of the negative-electrode solution in the second flow channel of the second layer of the charging cell included in the metal-air flow battery according to the fifth embodiment.

In the fifth embodiment, the control unit 112 switches the current I between a first current I1 and a second current I2, as shown in FIG. 7A. The second current I2 is larger than the first current I1.

As shown in FIG. 7B, the control unit 112 also maintains a flow rate VL at a constant flow rate VL1.

The first flow rate VL1 is a flow rate at which the negative electrode 98 exhibits a reduction reaction of the negative-electrode active-material ions 42 into the negative-electrode active-material particles 41a in a reduction state, but exhibits no hydrogen generation reaction conflicting the reduction reaction. The second flow rate VL2 is a flow rate at which the negative electrode 98 exhibits no reduction reaction, but exhibits a hydrogen generation reaction.

In the fifth embodiment, the control unit 112 controls the timings T2 and T4, at which the current I is switched from the second current I2 to the first current I1, in accordance with a feeding pressure P. This can limit the hydrogen generation reaction to a minimum extent necessary for removing the negative-electrode active-material particles 41a in the reduction state from the negative electrode 98, and discharging the removed negative-electrode active-material particles 41a in the reduction state from the charging cell 78. This can enhance charging efficiency.

The control unit 112 switches the flow rate VL from the second flow rate VL2 to the first flow rate VL1 in response to a rise ratio ΔP of the feeding pressure P exceeding an established rise ratio ΔPs.

FIG. 16 is a flowchart showing a process that is performed by the control unit included in the metal-air flow battery according to the fifth embodiment.

The control unit 112 executes Steps S151 to S154 shown in FIG. 16.

In Steps S151 to S153, process steps similar to those performed in Steps S111 to S113 shown in FIG. 8 are performed.

In subsequent Step S154, the control unit 112 determines whether the rise ratio ΔP of the feeding pressure P is larger than the established rise ratio ΔPs. If determining that the rise ratio ΔP of the feeding pressure P is larger than the established rise ratio ΔPs, the control unit 112 executes Step S151. If determining that the rise ratio ΔP of the feeding pressure P is smaller than the established rise ratio ΔPs, the control unit 112 executes Step S153.

Through Steps S153 and S154, the current I remains at the second current I2 until the rise ratio ΔP of the feeding pressure P reaches the established rise ratio ΔPs. Further, the state in which the current I remains at the second current I2 ends in synchronization with the rise ratio ΔP of the feeding pressure P reached the established rise ratio ΔPs.

### 6 Sixth Embodiment

The following describes a point in which the sixth embodiment is different from the fourth embodiment. With regard to what will not be described, a configuration similar to the configuration adopted in the fourth embodiment will be adopted in the sixth embodiment as well.

In the sixth embodiment, the control unit 112 controls a flow rate VL in accordance with a feeding pressure P.

FIG. 9A is a graph showing example time variations in the current flowing between the positive and negative electrodes of the charging cell included in the metal-air flow battery according to the sixth embodiment. FIG. 9B is a graph showing example time variations in the flow rate of the negative-electrode solution in the second flow channel of the second layer of the charging cell included in the metal-air flow battery according to the sixth embodiment.

In the sixth embodiment, the control unit 112 switches a current I between a first current I1 and a second current I2, as shown in FIG. 9A. The second current I2 is larger than the first current I1.

As shown in FIG. 9B, the control unit 112 also switches the flow rate VL between a first flow rate VL1 and a second flow rate VL2. The second flow rate VL2 is lower than the first flow rate VL1.

The first current I1 is a current at which the negative electrode 98 exhibits a reduction reaction of the negative-electrode active-material ions 42 into the negative-electrode active-material particles 41a in a reduction state, but exhibits no hydrogen generation reaction conflicting the reduction reaction. The second current I2 is a current at which the negative electrode 98 exhibits no reduction reaction, but exhibits a hydrogen generation reaction conflicting the reduction reaction.

The first flow rate VL1 is a flow rate at which the negative electrode 98 exhibits a reduction reaction of the negative-electrode active-material ions 42 into the negative-electrode active-material particles 41a in a reduction state, but exhibits no hydrogen generation reaction conflicting the reduction reaction. The second flow rate VL2 is a flow rate at which the negative electrode 98 exhibits no reduction reaction, but exhibits a hydrogen generation reaction.

Based on the feeding pressure P, the control unit 112 controls timings T2 and T4 at which the flow rate VL and the current I are switched from the second flow rate VL2 as well as the second current I2 to the first flow rate VL1 as well as the first current I1. This can limit the hydrogen generation reaction to a minimum extent necessary for removing the negative-electrode active-material particles 41a in the reduction state from the negative electrode 98, and discharging the removed negative-electrode active-material particles 41a in the reduction state from the charging cell 78. This can enhance charging efficiency.

In response to a rise ratio ΔP of the feeding pressure P exceeding an established rise ratio ΔPs, the control unit 112 switches the flow rate VL and the current I from the second flow rate VL2 as well as the second current I2 to the first flow rate VL1 as well as the first current I1.

FIG. 17 is a flowchart showing a process that is performed by the control unit included in the metal-air flow battery according to the sixth embodiment.

In the sixth embodiment, the control unit 112 executes Steps S161 to S164 shown in FIG. 17.

In Steps S161 to S163, process steps similar to those performed in Steps S121 to S123 shown in FIG. 10 are performed.

In subsequent Step S164, the control unit 112 determines whether the rise ratio ΔP of the feeding pressure P is larger than the established rise ratio ΔPs. If determining that the rise ratio ΔP of the feeding pressure P is larger than the established rise ratio ΔPs, the control unit 112 executes Step S161. If determining that the rise ratio ΔP of the feeding pressure P is smaller than the established rise ratio ΔPs, the control unit 112 executes Step S163.

Through Steps S163 and S164, the current I remains at the second current I2, and the flow rate VL remains at the second flow rate VL2 until the rise ratio ΔP of the feeding pressure P reaches the established rise ratio ΔPs. Further, the state in which the current I remains at the second current I2, and the flow rate VL is set at the second flow rate VL2 ends in synchronization with the rise ratio ΔP of the feeding pressure P reached the established rise ratio ΔPs.

FIG. 11A is also a graph showing example time variations in the current flowing between the positive and negative electrodes of the charging cell included in the metal-air flow battery according to a first modification of the sixth embodiment. FIG. 11B is also a graph showing example time variations in the flow rate of the negative-electrode solution in the second flow channel of the second layer of the charging cell included in the metal-air flow battery according to the first modification of the sixth embodiment.

In the first modification of the sixth embodiment, the second flow rate VL2 stands at zero, as shown in FIG. 11B. At the second flow rate VL2 that stands at zero, the durations of the time periods T1-T2 and T3-T4, during which a hydrogen generation reaction occurs, can be shorter than those at the second flow rate VL2 that is larger than zero, so that electric power consumed by the pump 75 and other auxiliary equipment can be reduced.

FIG. 12A is also a graph showing example time variations in the current flowing between the positive and negative electrodes of the charging cell included in the metal-air flow battery according to a second modification of the sixth embodiment. FIG. 12B is also a graph showing example time variations in the flow rate of the negative-electrode solution in the second flow channel of the second layer of the charging cell included in the metal-air flow battery according to the second modification of the sixth embodiment.

In the second modification of the sixth embodiment, when the rise ratio ΔV1 of the voltage V in the time period T3-T4, during which a hydrogen generation reaction occurs this time, is not lower than the rise ratio ΔV2 of the voltage V in the time period T1-T2, during which a hydrogen generation reaction occurred the last time, the control unit 112 continues, even on or after the timing T4, switching the current I and the flow rate VL between the first current I1 as well as the first flow rate VL1 and the second current I2 as well as the second flow rate VL2.

However, when the rise ratio ΔV1 of the voltage V in the time period T3-T4, during which a hydrogen generation reaction occurs this time, is lower than the rise ratio ΔV2 of the voltage V in the time period T1-T2, during which a hydrogen generation reaction occurred the last time, the control unit 112 performs maintenance in the subsequent time period T4-T5. When starting the maintenance, the control unit 112 maintains the current I at the second current I2, as shown in FIG. 12A, and switches the flow rate VL from the second flow rate VL2 to a third flow rate VL3, as shown in FIG. 12B. The third flow rate VL3 has a sign opposite to the sign of the second flow rate VL2. The third flow rate VL3 may have the same absolute value as the absolute value of the second flow rate VL2, or have an absolute value different from the absolute value of the second flow rate VL2.

A hydrogen generation reaction occurs during the maintenance. This facilitates removing the negative-electrode active-material particles 41a in the reduction state from the negative electrode 98, and discharging the removed negative-electrode active-material particles 41a in the reduction state from the charging cell 78.

In addition, the negative-electrode solution 97 flows through the second flow channel 96e of the second layer 96 in a reverse direction during the maintenance. Accordingly, a force having a direction opposite to the direction of a force exerted on the negative-electrode active-material particles 41a in the reduction state before the maintenance is exerted on the negative-electrode active-material particles 41a in the reduction state. This further facilitates removing the negative-electrode active-material particles 41a in the reduction state from the negative electrode 98, and discharging the removed negative-electrode active-material particles 41a in the reduction state from the charging cell 78.

FIG. 18 is a flowchart showing a process that is performed by the control unit included in the metal-air flow battery according to the second modification of the sixth embodiment.

In the second modification of the sixth embodiment, the control unit 112 executes Steps S171 to S176 shown in FIG. 18.

In Steps S171 to S173, process steps similar to those performed in Steps S131 to S133 shown in FIG. 13 are performed.

In subsequent Step S174, the control unit 112 determines whether the rise ratio ΔP of the feeding pressure P is larger than the established rise ratio ΔPs. If determining that the rise ratio ΔP of the feeding pressure P is larger than the established rise ratio ΔPs, the control unit 112 executes Step S175. If determining that the rise ratio ΔP of the feeding pressure P is smaller than the established rise ratio ΔPs, the control unit 112 executes Step S173.

In Step S175, the control unit 112 determines whether the rise ratio ΔP1 of the feeding pressure V in a time period during which the current I and the flow rate VL are set at the second current I2 and the second flow rate VL2, respectively, this time is smaller than the rise ratio ΔP2 of the feeding pressure P in a time period during which the current I and the flow rate VL were set at the second current I2 and the second flow rate VL2, respectively, the last time. If determining that the rise ratio ΔP1 of the feeding pressure P is smaller than the rise ratio ΔP2 of the feeding pressure P, the control unit 112 executes Step S176, followed by Step S171. If determining that the rise ratio ΔP1 of the feeding pressure P is not smaller than the rise ratio ΔP2 of the feeding pressure P, the control unit 112 executes Step S171 without executing Step S176.

### 7 Seventh Embodiment

The following describes a point in which the seventh embodiment is different from the first to sixth embodiments. With regard to what will not be described, a configuration similar to the configurations adopted in the first to sixth embodiments will be adopted in the seventh embodiment as well.

FIGS. 19 to 22 illustrate a process that is performed by the control unit included in the metal-air flow battery according to the seventh embodiment.

In the first to sixth embodiments, the control unit 112 controls the durations of the time periods T1-T2 and T3-T4, during which a hydrogen generation reaction occurs, by controlling the current I and/or the flow rate VL in response to the rise ratio ΔV of the voltage V exceeding the established rise ratio ΔVs, or the rise ratio ΔP of the feeding pressure P exceeding the established rise ratio ΔPs.

In the seventh embodiment by contrast, the control unit 112 controls the durations of the time periods T1-T2 and T3-T4, during which a hydrogen generation reaction occurs, in accordance with a depth D of discharge in the discharging unit 24 by controlling the current I and/or the flow rate VL further in accordance with the depth D of discharge in the discharging unit 24, as illustrated in FIG. 19.

For instance, in switching the flow rate VL between a first flow rate VL1 and a second flow rate VL2, like the first embodiment, the control unit 112 controls the flow rate VL in accordance with the depth D of discharge of the discharging unit 24 to, as illustrated in FIG. 20, bring forward timings T2 and T4 of switching of the flow rate VL from the second flow rate VL2 to the first flow rate VL1 along with decrease in the depth D of discharge in the discharging unit 24 to shorten the durations of the time periods T1-T2 and T3-T4, during which a hydrogen generation reaction occurs.

Alternatively, in switching the current I between the first current I1 and the second current I2, like the second embodiment, the control unit 112 controls the current I in accordance with the depth D of discharge in the discharging unit 24 to, as illustrated in FIG. 21, bring forward a timing for switching the current I from the second current I2 to the first current I1 along with decrease in the depth D of discharge in the discharging unit 24 to shorten the durations of the time periods T1-T2 and T3-T4, during which a hydrogen generation reaction occurs.

Alternatively, in switching the flow rate VL and the current I between the first flow rate VL1 as well as the first current I1 and the second flow rate VL2 as well as the second current I2, like the third embodiment, the control unit 112 controls the flow rate VL and the current I in accordance with the depth D of discharge in the discharging unit 24 to, as illustrated in FIG. 22, bring forward a timing for switching the flow rate VL and the current I from the second flow rate VL2 as well as the second current I2 to the first flow rate VL1 as well as the first current I1 along with decrease in the depth D of discharge in the discharging unit 24 to shorten the durations of the time periods T1-T2 and T3-T4, during which a hydrogen generation reaction occurs.

At a shallow depth D of discharge in the discharging unit 24, the negative-electrode active-material ions 42 contained in the negative electrode liquid 97 are small in number, so that a hydrogen generation reaction is likely to progress. At a deep depth D of discharge in the discharging unit 24 on the other hand, the negative-electrode active-material ions 42 contained in the negative electrode liquid 97 are small in number, so that a hydrogen generation reaction is less likely to progress. As such, shortening the durations of the time periods T1-T2 and T3-T4, during which a hydrogen generation reaction occurs, along with decrease in the depth D of discharge in the discharging unit 24 enables the hydrogen generation reaction to progress to a proper extent.

The discharge in the discharging unit 24 and the charge in the charging unit 25 are performed alternately.

The control unit 112 can obtain the depth D of discharge in the discharging unit 24 from the product of a current discharged by the discharging unit 24 and a time during which the discharging unit 24 discharges the current. The determined depth D of discharge in the discharging unit 24 is the depth of discharge in the discharging unit 24 at the latest time point when the discharging unit 24 finished discharge. The current discharged by the discharging unit 24 is a constant current.

The depth D of discharge indicates a value (quotient) obtained by dividing the foregoing product (Ah) of the discharged current and discharging time by an initial (pre-discharge) capacity Ah of the negative-electrode solution 97 (when zinc magnesium is contained, the capacity is M×0.82). That the depth D of discharge is deep means that the value obtained by dividing “the product of the current discharged by the discharging unit 24 and the time of discharge in the discharging unit 24” by “the capacity of the negative-electrode solution 97 before the discharge” is greater than 0.1 (a 10% depth). That the depth D of discharge is shallow means that the value obtained by dividing “the product of the current discharged by the discharging unit 24 and the time of discharge in the discharging unit 24” by “the capacity of the negative-electrode solution 97 before the discharge” is smaller than 0.1 (a 10% depth).

The present disclosure is not limited to the above-described embodiments. The present disclosure may be replaced with a configuration substantially identical to that described in the above-described embodiments, a configuration that provides the same action and effect, or a configuration that can achieve the same object.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A charging system for a metal-air flow battery, comprising:
a first layer including a first flow channel;
a positive electrode facing the first flow channel;
a second layer including a second flow channel;
a negative electrode facing the second flow channel;
a separator separating the first and second flow channels from each other;
a positive-electrode solution flowing through the first flow channel; and
a negative-electrode solution flowing through the second flow channel,
wherein the charging system for the metal-air flow battery has a time period during which hydrogen is generated in the negative electrode.

2. The charging system for the metal-air flow battery according to claim 1, comprising a controller configured to control, in accordance with a voltage applied between the positive and negative electrodes, at least one selected from the group consisting of a flow rate of the negative-electrode solution, and a current flowing between the positive and negative electrodes.

3. The charging system for the metal-air flow battery according to claim 2, wherein
the controller switches the flow rate between a first flow rate and a second flow rate lower than the first flow rate, and
controlling the flow rate in accordance with the voltage includes controlling a timing for switching the flow rate from the second flow rate to the first flow rate in accordance with the voltage.

4. The charging system for the metal-air flow battery according to claim 3, wherein controlling the timing in accordance with the voltage includes switching the flow rate from the second flow rate to the first flow rate in response to a rise ratio of the voltage exceeding an established rise ratio.

5. The charging system for the metal-air flow battery according to claim 3, wherein the first flow rate is a flow rate at which a hydrogen generation reaction does not occur in the negative electrode, and
the second flow rate is a flow rate at which the hydrogen generation reaction occurs in the negative electrode.

6. The charging system for the metal-air flow battery according to claim 3, wherein the second flow rate stands at zero.

7. The charging system for the metal-air flow battery according to claim 2, wherein
the controller switches the current between a first current and a second current larger than the first current, and
controlling the current in accordance with the voltage includes controlling a timing for switching the current from the second current to the first current in accordance with the voltage.

8. The charging system for the metal-air flow battery according to claim 7, wherein controlling the timing in accordance with the voltage is switching the current from the second current to the first current in response to a rise ratio of the voltage exceeding an established rise ratio.

9. The charging system for the metal-air flow battery according to claim 7, wherein
the first current is a current at which a hydrogen generation reaction does not occur in the negative electrode, and
the second current is a current at which the hydrogen generation reaction occurs in the negative electrode.

10. The charging system for the metal-air flow battery according to claim 2, wherein
the controller switches the flow rate and the current between a first flow rate as well as a first current and a second flow rate as well as a second current, the second flow rate being lower than the first flow rate, the second current being larger than the first current, and
controlling the flow rate and the current in accordance with the voltage includes controlling a timing for switching the flow rate and the current from the second flow rate as well as the second current to the first flow rate as well as the first current in accordance with the voltage.

11. The charging system for the metal-air flow battery according to claim 10, wherein controlling the timing in accordance with the voltage includes switching the flow rate and the current from the second flow rate as well as the second current to the first flow rate as well as the first current in response to a rise ratio of the voltage exceeding an established rise ratio.

12. The charging system for the metal-air flow battery according to claim 10, wherein
the first flow rate and the first current are a flow rate and a current, respectively, at both of which a hydrogen generation reaction does not occur in the negative electrode, and
the second flow rate and the second current are a flow rate and a current, respectively, at both of which the hydrogen generation reaction occurs in the negative electrode.

13. The charging system for the metal-air flow battery according to claim 10, wherein the second flow rate stands at zero.

14. The charging system for the metal-air flow battery according to claim 10, wherein controlling the flow rate and the current in accordance with the voltage includes switching the flow rate from the second flow rate to a third flow rate in accordance with the voltage, the third flow rate having a sign opposite to a sign of the second flow rate.

15. The charging system for the metal-air flow battery according to claim 14, wherein switching the flow rate from the second flow rate to the third flow rate in accordance with the voltage includes switching the flow rate from the second flow rate to the third flow rate when a rise ratio of the voltage with the flow rate and the current being set at the second flow rate and the second current, respectively, is lower than the rise ratio of the voltage with the flow rate and the current being, last time, set at the second flow rate and the second current, respectively.

16. A metal-air flow battery comprising:
the charging system for the metal-air flow battery according to claim 1;
a discharging unit for the metal-air flow battery; and
a controller configured to control at least one selected from the group consisting of the flow rate and the current in accordance with a depth of discharge in the discharging unit for the metal-air flow battery.

17. The metal-air flow battery according to claim 16, wherein
the controller controls the flow rate in accordance with the depth of discharge,
the controller switches the flow rate between a first flow rate and a second flow rate lower than the first flow rate, and
controlling the flow rate in accordance with the depth of discharge includes bringing forward a timing for switching the flow rate from the second flow rate to the first flow rate along with decrease in the depth of discharge.

18. The metal-air flow battery according to claim 16, wherein
the controller controls the current in accordance with the depth of discharge,
the controller switches the current between a first current and a second current larger than the first current, and
controlling the current in accordance with the depth of discharge includes bringing forward a timing for switching the current from the second current to the first current along with decrease in the depth of discharge.

19. The metal-air flow battery according to claim 16, wherein
the controller controls the flow rate and the current in accordance with the depth of discharge,
the controller switches the flow rate and the current between a first flow rate as well as a first current and a second flow rate as well as a second current, the second flow rate being lower than the first flow rate, the second current being larger than the first current, and
controlling the flow rate and the current in accordance with the depth of discharge includes bringing forward a timing for switching the flow rate and the current from the second flow rate as well as the second current to the first flow rate as well as the first current.
